(19) United States
(12) Patent Application Publication
(10) Pub. No.: US 2015/0120390 A1
(43) Pub. Date: Apr. 30, 2015

(54) RECEIVING, TRACKING AND ANALYZING BUSINESS INTELLIGENCE DATA

(71) Applicant: Goodsmitch, Inc., Solana Beach, CA (US)

(72) Inventor: Rob Pace, Rancho Santa Fe, CA (US)

(21) Appl. No.: 14/592,754

(22) Filed: Jan. 8, 2015

Related U.S. Application Data
(63) Continuation of application No. 14/165,417, filed on Jan. 27, 2014.
(60) Provisional application No. 61/759,568, filed on Feb. 1, 2013.
(60) Provisional application No. 61/759,575, filed on Feb. 1, 2013.
(60) Provisional application No. 61/836,146, filed on Jun. 17, 2013.
(60) Provisional application No. 61/846,706, filed on Jul. 16, 2013.

(51) Int. Cl. G06Q 30/02; G06F 3/0484

(52) U.S. Cl. CPC G06Q 30/0203; G06F 3/0484
USPC 705/7.32

(57) ABSTRACT

Receiving, tracking, and analyzing business intelligence data. In one aspect, the present disclosure relates to computer-implemented techniques for obtaining feedback data from users of a product, process or service, associating the feedback data with net promoter or other score values, performing analytic reporting based on the feedback data, and dynamically modifying the manner of obtaining the feedback data.

### CROSS-REFERENCE TO RELATED APPLICATIONS

This application claims the benefit under 35 U.S.C. §120 as a Continuation of U.S. application Ser. No. 14/165,417, filed Jan. 27, 2014, which claims the benefit under 35 U.S.C. §119(e) of Provisional Appln. Nos.: 61/759,568, filed Feb. 1, 2013; 61/759,575, filed Feb. 1, 2013; 61/836,146, filed Jun. 17, 2013; and 61/846,706, filed Jul. 16, 2013. The entire contents of each of the forgoing applications is hereby incorporated by reference as if fully set forth herein. Further, the applicant(s) hereby rescind any disclaimer of claim scope in the parent application(s) or the prosecution history thereof and advise the USPTO that the claims in this application may be broader than any claim in the parent application(s).

### FIELD OF THE DISCLOSURE

The present disclosure generally relates to obtaining and applying analytics to feedback data from users of a product or service. The disclosure relates more specifically to computer-implemented techniques for obtaining feedback data from users of a product, process or service, associating the feedback data with net promoter or other score values, performing analytic reporting based on the feedback data, and dynamically modifying the manner of obtaining the feedback data.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Feedback from users of a product or service, such as customer feedback or data that affects customer service, business offerings, business-to-consumer relationships, and business-to-business relationships, has become vital to the continued success and growth of business entities that wish to use customer opinion and suggestions to improve market share, profitability, or customer service. However, feedback typically is obtained from customers in ways that are inconvenient to the customer, that are unlikely to gain customer compliance, or that provide data unhelpful to the collecting business. Accordingly, customers are rarely willing to provide feedback, and the feedback, when provided, rarely has any effect on a business or a customer's relationship with the business. The same problems exist with business-to-business and/or supply chain feedback, although feedback in those contexts is even more rarely collected.

For example, the use of typical feedback techniques may take from three to eight minutes for a user or consumer to complete. Users and customers may know the expected length of time required to complete surveys or feedback mechanisms, so the users and customers generally avoid giving feedback to businesses. The customers who are willing to provide feedback tend to deliver more negative feedback—a phenomenon termed negative skew. These customers typically are externally motivated, such as by a particularly bad experience, to deal with the frustration at the lengthy period of time it will take to complete a survey, for example.

Therefore, the need exists for an approach to consumer to business, and business to business, feedback that can provide increased frequency of feedback collection, improved quality of feedback, and improved feedback data that is more usable for multiple business related purposes.

### BRIEF DESCRIPTION OF THE DRAWINGS

In the drawings:

FIG. 1 illustrates an example networked computer system that may be used to implement an embodiment.

FIG. 2 illustrates an example computer-implemented process that may be used in an embodiment.

FIG. 3 illustrates an example log in screen for an embodiment.

FIG. 4 is an example of a secondary screen, which may geo-locate the position of the user in an established business.

FIG. 5A, FIG. 5B, FIG. 5C, FIG. 5D illustrate example screen displays that may be used in various embodiments;

FIG. 6 illustrates an example data flow loop that may be used in embodiments;

FIG. 7A is an example report of data values for a plurality of records received for a particular entity over time.

FIG. 7B is an example analytical report that interprets data records of the type shown in FIG. 7A.

FIG. 8 illustrates an example computer system for one implementation of an embodiment.

FIG. 9, FIG. 10, FIG. 11, FIG. 12, FIG. 13, FIG. 14, FIG. 15, FIG. 16 illustrate example screen displays and graphical user interfaces that may be generated using computing devices and applications in various embodiments.

FIG. 17 illustrates a computer system with which embodiments may be used.

FIG. 18 is a three-part view that illustrates selecting an entity using a hierarchical approach.

FIG. 19 is a four-part view that illustrates first-level feedback prompts and three sets of successively presented second-level feedback prompts.

FIG. 20 illustrates an example graphical user interface that may be used to obtain feedback input for a particular individual associated with an entity.

### DETAILED DESCRIPTION OF EXAMPLE EMBODIMENTS

In the following description, for the purposes of explanation, numerous specific details are set forth in order to provide a thorough understanding of an embodiment. It will be apparent, however, that an embodiment may be practiced without these specific details. In other instances, well-known structures and devices are shown in block diagram form in order to avoid unnecessarily obscuring an embodiment.

### 1.0 Structural Overview of Example Embodiment

For purposes of this disclosure, a business entity may include for-profit and non-profit organizations, educational institutions, government institutions, or any group with a collective goal. It may also include segments within such entities such as a business unit.

In an embodiment, computer-implemented techniques are configured to obtain structured business intelligence data based on analytics applied to data received in response to a multi-level structured query directed to a logical grouping of respondents. The business intelligence may include, for example, feedback, surveys, or reviews. The data collected accounts for multiple variables, such as type of respondent (business or individual), type of business seeking responses (i.e., a restaurant, hotel, retail store, etc.), and geo-location. The business intelligence may be useful in configuring management decision systems, customer retention tools, brand strategies, experimental models, CRM tools, or other systems. In an embodiment, the results of analytics also may be used to dynamically reconfigure one or more levels of the structured query.

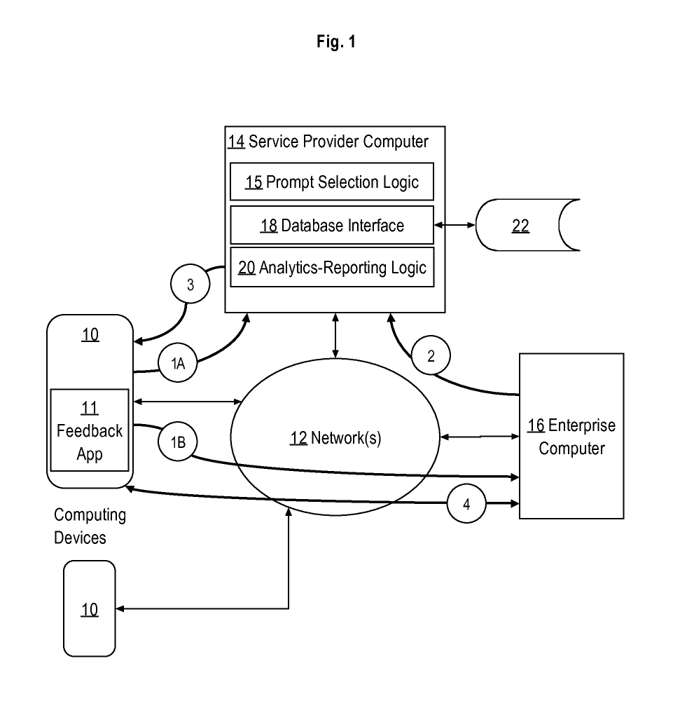

FIG. 1 illustrates an example networked computer system that may be used to implement an embodiment. In an embodiment, one or more computing devices 10 are communicatively coupled via one or more networks 12 to a service provider computer 14 and an enterprise computer 16. Examples of computing devices 10 include smartphones, tablet computers, laptop computers, netbook or ultrabook computers, desktop computers and any other computing device that may be configured or capable of performing the functions described herein. For purposes of illustrating a clear example, some embodiments herein are described with respect to use with mobile computing devices such as APPLE IPHONE devices, ANDROID devices, and other smartphones, but the broad functions described herein may be used with many other computing devices. For example, embodiments may be used with computers that use HTTP, HTML and web browsers rather than device-specific apps. Embodiments may be used with point of purchase computers, kiosk computers, and web installations. Other embodiments may be integrated with client computers of other existing systems to obtain combined data that is not available otherwise; for example, online commerce, point of sale, or kiosk-based purchasing systems may be integrated, and the responses provided through the techniques herein may support consumer decisions to increase the number of products that are purchased based on receiving data indicating that other respondents perceived a particular product to have value.

In an embodiment, each of the computing devices 10 has installed and executes a feedback application (“app”) 11 that is configured to perform certain functions as further described herein for presenting structured queries, receiving user feedback data about products, processes or services, and delivering the feedback data to the service provider computer 14 and enterprise computer 16. Various functions described herein may be implemented via calls of the app 11 using an application programming interface (API) implemented at the service provider computer and/or enterprise computer 16 whereby information is requested and/or delivered.

Networks 12 broadly represents any of a local area network, wide area network, and/or internetworks, alone or in combination, using any of wired, wireline, terrestrial or satellite links. Enterprise computer 16 typically comprises one or more server-class computers, data centers, or application instances hosted by a cloud service provider, and owned, operated, or associated with a business entity for which obtaining user feedback and analytics may be useful. For example, enterprise computer 16 may be associated with a restaurant, bar, hotel, airline, rental car firm, telecommunications carrier, hospital, or virtually any other type of business entity or other provider of goods or services for which obtaining user feedback and analytics may be useful.

Service provider computer 14 typically comprises one or more server-class computers, data centers, or application instances hosted by a cloud service provider, and owned, operated, or associated with a service provider that facilitates obtaining user feedback data, supporting the feedback app 11, performing analytics on the user feedback data, providing reports to the enterprise computer 16, and reconfiguring the feedback app.

Service provider computer 14 may serve as an intermediary or feedback hub from which enterprise computer 16 may obtain reports, analyses, summaries and/or aggregation of user feedback data relating to products or services of the enterprise. In some embodiments, service provider computer 14 may be co-located with enterprise computer 16, or the functions of the service provider computer may be integrated with the enterprise computer.

In an embodiment, service provider computer 14 comprises prompt selection logic 15, database interface 18, and analytics-reporting logic 20. In an embodiment, prompt selection logic 15 is configured to perform selecting and reconfiguring of content of structured queries that are presented to an end user via feedback app 11 to obtain user feedback data. Thus, prompt selection logic 15 may be configured to provide content and presentation data that drives a presentation layer of the feedback app 11 for the purpose of presenting a particular set of structured queries, prompts or screen displays to the end user. The database interface 18 may be configured to store and retrieve records using a data repository 22, which may comprise any of a relational database, graph database, object store, system of flat files, or other data storage system. In an embodiment, the analytics-reporting logic 20 is configured to perform aggregation, interpretation, cross-association, and other functions on records stored in data repository 22 and to generate reports that specify values based on the feedback data, as further described. In various embodiments, data repository 22 broadly represents one or more of a proprietary information database and one or more third party databases that the service provider computer 14 uses to supply business data.

As one example of use, in an embodiment, an end user of computing device 10 installs and opens feedback app 11. The feedback app presents a graphical user interface that is configured to prompt the user to select an enterprise and provide feedback about the enterprise. The user selects options and/or enters data in one or more forms, and selects an option indicating that input is complete. In response, the feedback app 11 causes sending a record representing the feedback data to the service provider computer 14 at operation lA and concurrently to the enterprise computer 16 at operation 1B. Thus, in an embodiment, the customer pushes feedback to both an intermediary in the form of service provider computer 14 and a business, represented by enterprise computer 16, at about the same time. This data push may be substantially structured, and may further be unfiltered in whole or in part.

At operation 2, data analyses and other interaction may occur between the enterprise computer 16 of the requesting business and the service provider computer 14 of the intermediary. At optional operation 3, the intermediary may provide a reward to the consumer that pushed feedback to the system. At optional operation 4, the requesting business may directly communicate with the consumer.

In one embodiment, a user initiates a search using the computing device 10 to identify an entity for which the computing device 10 will provide information. In one approach, the computing device 10 makes an API call made to the data repository 22. In response, the data repository 22 returns a result set to the computing device 10 based on a set of filters that are configured to best match the user's desired result set based in part upon the location of the computing device 10, prior practice of the computing device 10, and frequency of querying a particular category.

In this embodiment, as a next operation, the user selects, from among the results in the result set, a particular entity using the computing device 10. In response, the computing device 10 makes an API call to the data repository 22 to collect one or more unique experience labels based on one or more of Standard Industrial Classification (SIC) codes or North American Industry Classification System (NAICS) codes or other industry codes, standardized or proprietary. The experience labels are used to form a screen display comprising a plurality of user interface widgets, organized as a structured display such as a matrix, that are labeled with prompts relating to feedback responses associated with products or services. In an embodiment, the user navigates the structured selections (for example, a two-by-two matrix presenting options for good product, good service, bad product, bad service) that designates a type of feedback on computing device 10. The user is presented with experience labels for each type of feedback category using a plurality of additional screens, as further described.

In an embodiment, the computing device 10 submits the user-entered data via an API call to data repository 22 and is presented with a final comment screen customized for the categories of feedback. In an embodiment, the comment screen presents the user with a recommend selection opportunity based in general on Net Promoter Score® (NPS) theory or other customer loyalty score theory. In an embodiment, the user is also presented with suggested comments based on SIC or NAICS industry codes or other systems and industry category information, standardized or proprietary and customization of specific entity.

In an embodiment, the computing device 10 submits feedback by API call to data repository 22 and is returned a custom confirmation page based on prior selections and nature of feedback such as positive or negative. In an embodiment, the user's feedback is stored on computing device 10 for future reference and use.

In some embodiments, in the final comment screen, the user is presented with suggested comments based on one or more of (i) past comment selection (ii) analysis of unstructured comment data to track repeated information and present that as a potential comment, (iii) comments aggregate users have made about specific entity or industry class. In an embodiment, these comments are structured data and facilitate automatic computer analysis.

In some embodiments, the experience labels used in screen displays that prompt for user input about specific product, process or service experience are automatically updated and re-ordered based on one or more of (i) past user selection (ii) analysis of unstructured user comment data to track repeated information and present that as a potential label, (iii) selections and comments by aggregate users about specific entity or industry class.

In some embodiments, the NPS score that the user should have entered will be predicted based on weighted multi-variable correlation analysis. Such analysis will be able to suggest whether a business will or will not be recommended by specific experience factors. For example, user responses of Bad Food and Good Service may result in a 73% probability that the user will recommend the business, whereas user responses of Good Food and Bad Service might result in a 20% probability that the user would recommend the business.

In some embodiments, the user is presented with intensity bars or measures to indicate the significance of each experience label or the aggregate positive or negative experience. For example, for a restaurant, user responses of Good portion size at 10% intensity and Bad Service at 70% intensity may result in a specific NPS score. In an embodiment, automatic data analysis can correlate responses such as “Value” to other responses or buttons selected; embodiments provide not only tying responses to NPS but permit analysis of any structured variable in the context of other structured variables.

In some embodiments, the user is presented with alternate or additional labels, screens, and experiences based on frequency of feedback for any entity. For example, the more times that a particular user submits feedback for a particular entity, the more specific or expansive the experience becomes, as displayed through user interface screens in feedback app 11.

In some embodiments, all active data, such as user volitional selections, and passive data, such as location of computing device 10, time, duration, use sequences, and other metadata received from the computing device 10 are stored in repository 22. In one embodiment, business entities may request or run specific reports against (i) data on their specific entity and/or (ii) aggregated data on markets. In an embodiment, automatic data analysis techniques can perform correlations across multiple businesses or industries and not just one company. For example, in healthcare, predictive values can be determined related to future outcomes of patient satisfaction surveys; embodiments can support improvement in patient satisfaction scores after discharge, which may influence insurers' reimbursement rates. Obtaining data in response to the use of the favorites option described herein and providing the data in reports to enterprise computer 16 may help give the enterprise a structured profile of what is important to a consumer. For example, data analysis processes can provide business intelligence to a business on what a consumer values even if the consumer does not enter text comments about particular values for a specific business. As a result, a business receiving the information may be able to identify new product ideas based upon the responses that indicate favorites of consumers. In this manner, embodiments provide greater consumer profiling that is based at least in part upon actual consumer visits to a business and/or experiences with a business.

### 2.0 Operation in Example Embodiments

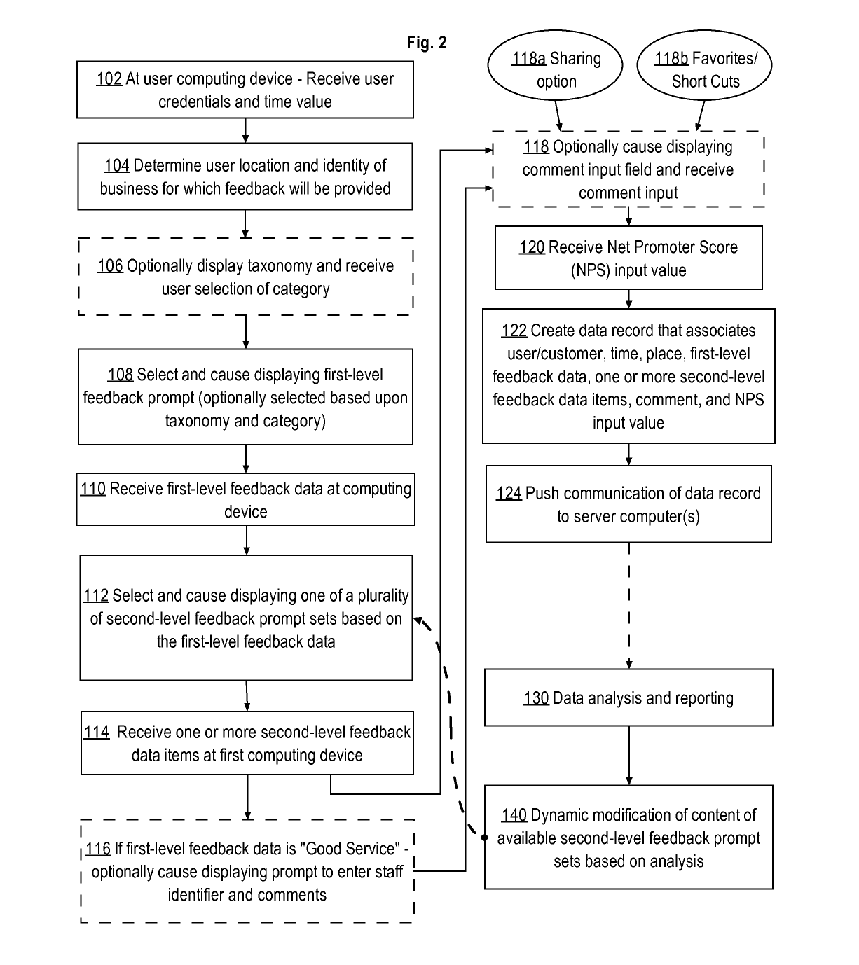

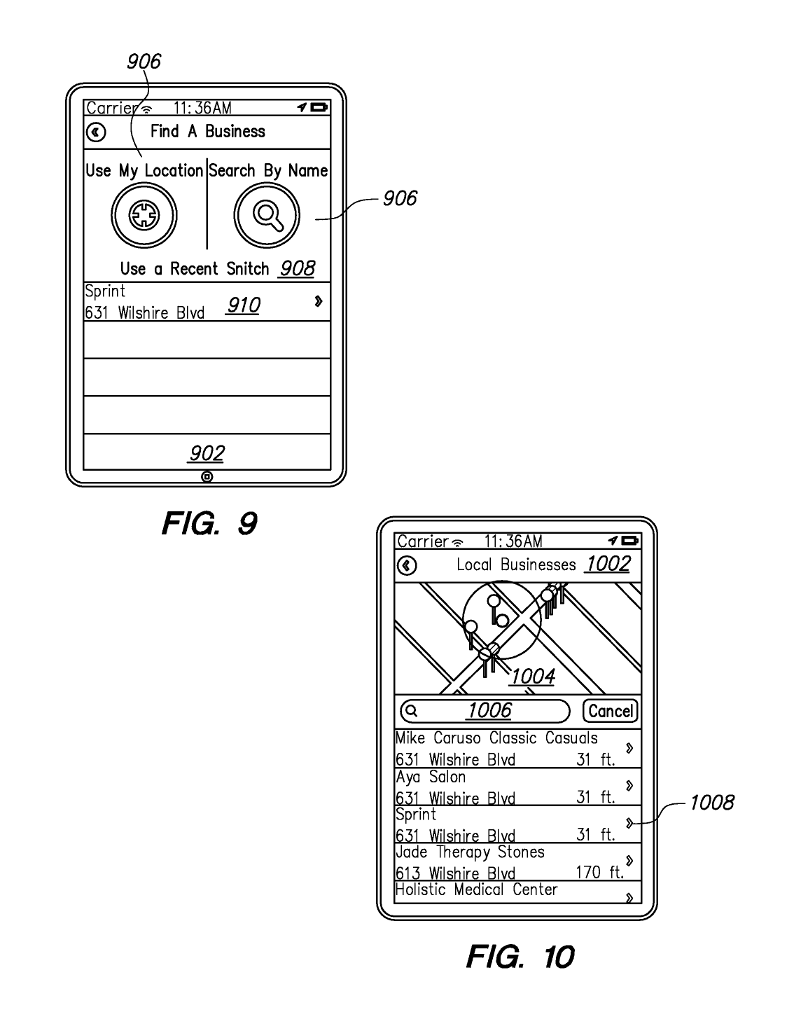

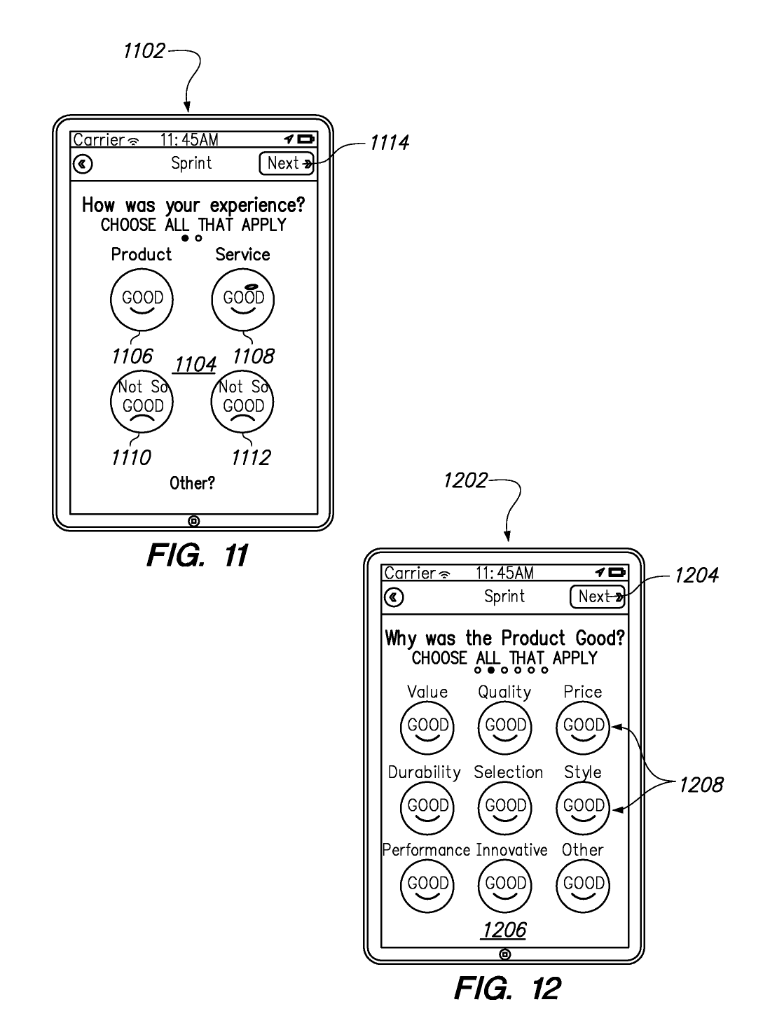

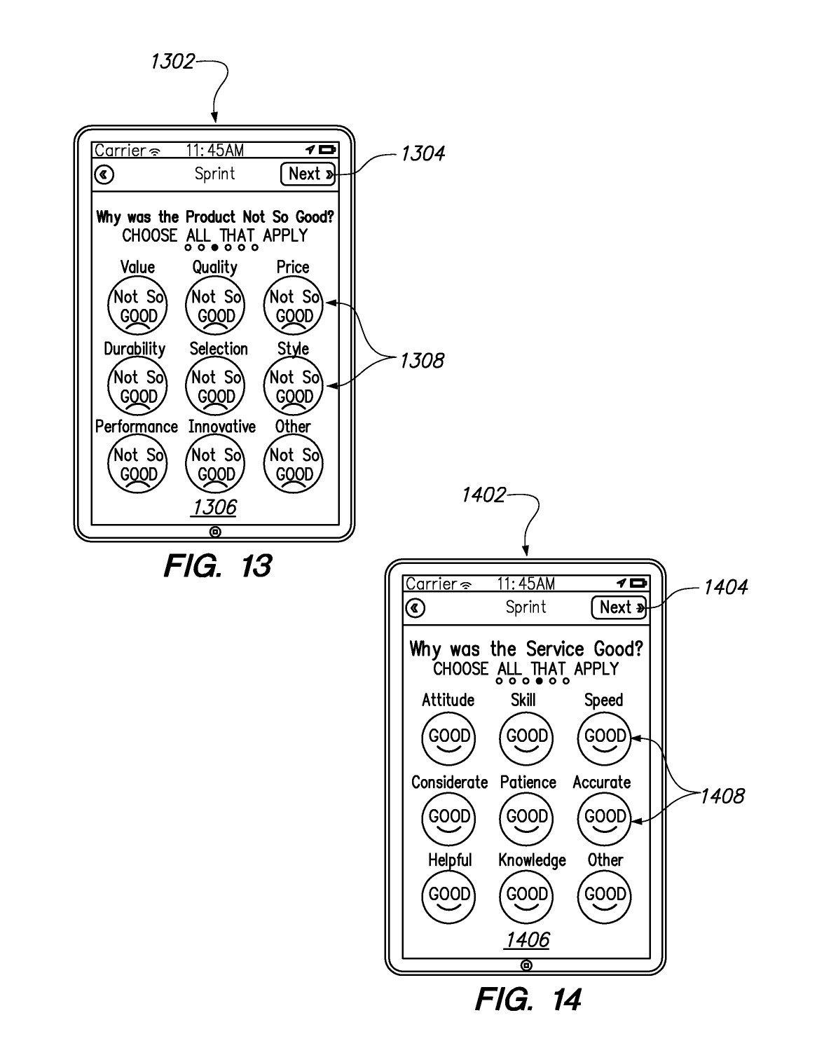

FIG. 2 illustrates an example computer-implemented process that may be used in an embodiment. For purposes of illustrating a clear example, aspects of FIG. 2 may be described in connection with the system example of FIG. 1 and the graphical user interface example of FIG. 9, FIG. 10, FIG. 11, FIG. 12, FIG. 13, FIG. 14, FIG. 15, FIG. 16, but the process of FIG. 2 is not limited to that particular context.

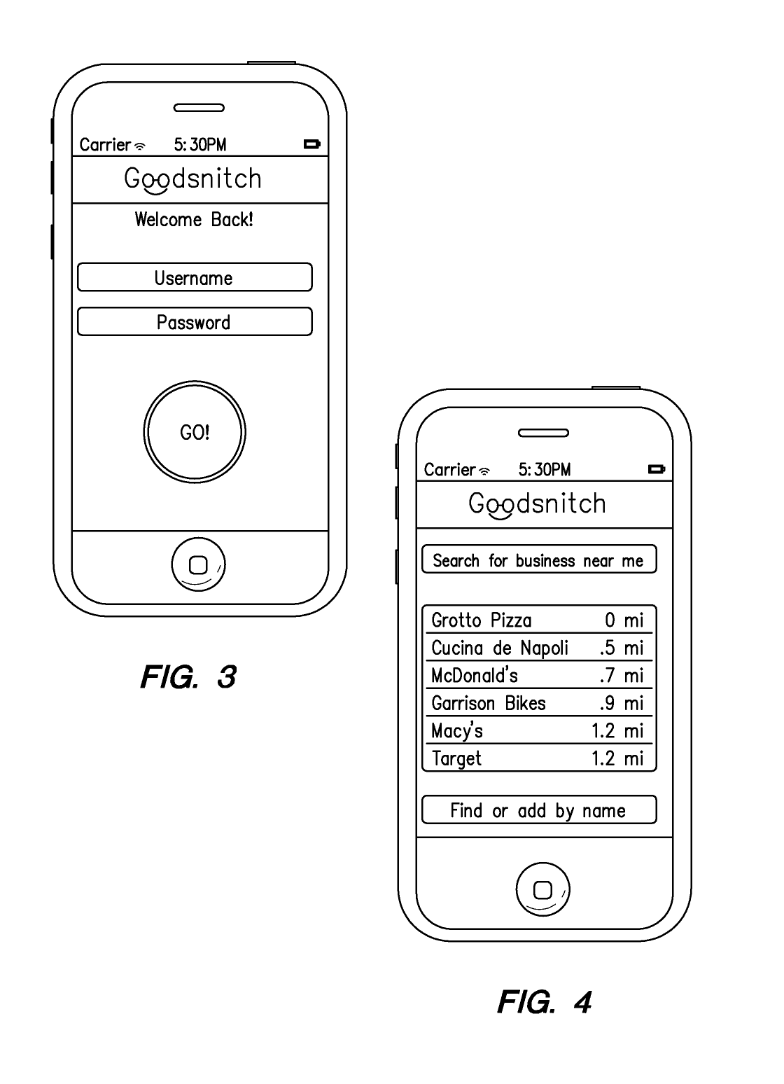

At block 102, at a user computing device such as computing device 10, the process receives user credentials and a time value. For example, a user identifier and password are received and authenticated to establish a user identity or account association for subsequent communication interactions. User credentials may be received in response to app 11 generating a GUI screen display of the type shown in FIG. 3, for example. The time value may be received from the clock of the user computing device so that an approximate time can be associated with user-supplied data or responses.

At block 104, the process determines a user location and an identity of a business for which feedback will be provided. For example, in the case of a mobile computing device, app 11 may query location services on the device to obtain a geo-location for the device and obtain latitude and longitude values or other location information in other formats. App 11 may use the location data to retrieve, from the service provider computer 14, a list of participating business entities that are near the then-current location of the computing device, and may present the list in a screen display of a graphical user interface that the app generates. Based on the list, the user may provide input to select a particular business for which the user wishes to provide feedback. The selected business could be the place where the user is presently located, or could be a place that the user recently visited, for example. The use of favorite and recent responses provides frequency related information tied to subsequent data.

FIG. 9 illustrates a screen display that may be used to support finding an identity of a business, in an embodiment. In this example, screen display 902 comprises a location widget 904, name search widget 906, recent record link 908, and business listing 910. In an embodiment, location widget 904 is configured to receive a tap, click or other user selection and, in response, to generate a display as seen in FIG. 10. In an embodiment, name search widget 906 is configured to receive a user selection indicating a request to search for a specific business name; in response, the app 11 may cause generating a screen display that prompts the user to enter a specific business name, and may initiate a search query to data repository 22 to locate one or more matching business names that are nearby, as indicated by geo-location data from the computing device 10.

In an embodiment, recent record link 908 is configured, in response to user selection, to retrieve and display a list of businesses associated with feedback records that the user provided in the recent past. For example, the business listing 910 may indicate a business for which feedback was provided recently. Additionally or alternatively, the business listing may be blank initially, and may be updated when the recent record link 908 is selected. Additionally or alternatively, the business listing 910 may be updated based on geo-location data in real time as the user is deciding what to input into screen display 902.

FIG. 10 illustrates a screen display that may be used to support finding an identity of a business, in an embodiment. In an embodiment, a screen display 1002 comprises a map region 1004, search field 1006, and business list 1008. In an embodiment, the map region 1004 is configured to display a pin or other graphical icon indicating a position of the computing device in a geographical map of a nearby region, and to display pins for one or more businesses that are near the computing device's position and for which feedback may be provided. The search field 1006 is configured to receive user input for the name of a particular business. The business list 1008 may be generated dynamically by app 11 in response to receiving data from data repository 22 that identifies names, addresses, and distances for nearby businesses that are represented by the pins in the graphical map. In this manner, based on the current geo-location of the user's computing device, the user may receive a graphical map and a text list of business that are nearby for which feedback may be provided.

At block 106, optionally the process displays a taxonomy and receives a user selection of a category. For example, in some embodiments app 11 generates a user interface page that presents a list or hierarchy of categories for which feedback may be provided. The hierarchy may have any number of levels presented in successive user interface screens. The use of a taxonomy may enable a particular business or other entity to organize feedback according to criteria that are useful to management or that are relevant to its particular units, products, services, processes, events or issues. For example, an airline could define a taxonomy that includes categories of Booking Process, Ticketing Process, Check-in Process, Gate Services, Cabin Crew Service, Flight Operations, Baggage Service, Food Service, and other external and internal facing categories.

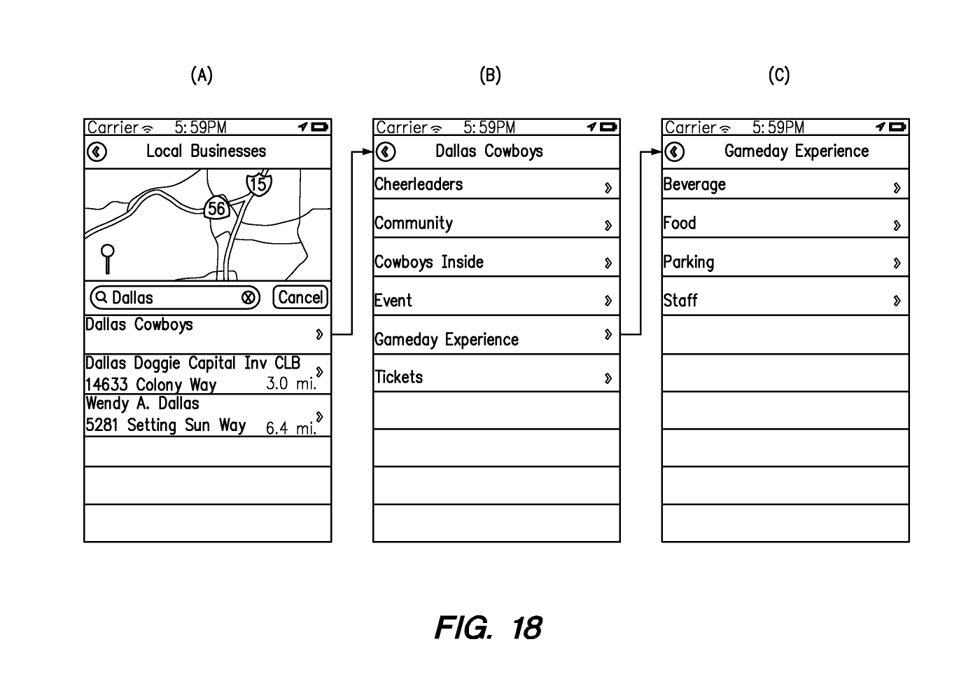

FIG. 18 is a three-part view that illustrates selecting an entity using a hierarchical approach. The example graphical user interface of FIG. 18 view (A) may comprise elements similar to those previously described for FIG. 10. In the example of FIG. 18 view (A), a user has entered DALLAS in the search field 1006 and received three (3) search result items. Assume that the user selects DALLAS COWBOYS from the search results. In response, app 11 generates and causes displaying FIG. 18 view (B), which presents a taxonomy of categories relating to the DALLAS COWBOYS business. Assume that the user selects GAMEDAY EXPERIENCE from the taxonomy; in response, app 11 generates and causes displaying FIG. 18 view (C), which presents a next-level list of categories within the taxonomy relating to the GAMEDAY EXPERIENCE category.

At block 108, the process selects and causes displaying a first-level feedback prompt. For example, app 11 generates and displays a two-by-two matrix of first-level feedback options that the user may select. Options in the matrix may include: Good Product; Good Service; Not-so-good Product; Not-so-good Service. Optionally, the number of first-level feedback options and labels for the options are selected based upon the category that the user provided at block 106. In an embodiment, the first-level feedback prompts may relate to any suitable initial summary category such as products, processes, service, or programs.

FIG. 11 illustrates an example screen display comprising a two-by-two matrix of first-level feedback options that the user may select. In one embodiment, screen display 1102 comprises a matrix 1104 of icons 1106, 1108, 1110, 1112 that are respectively associated with first-level user feedback responses of Good Product, Good Service, Not So Good Product 1110, and Not So Good Service 1112. Other embodiments may use other arrangements of icons and other labels or content for responses. Each of the icons 1106, 1108, 1110, 1112 is configured as an active GUI widget which, when selected, causes communicating a corresponding response data item to the app 11 to be included in a record that is communicated to the service provider computer 14.

At block 110, first-level feedback data is received at the computing device. For example, app 11 may receive data indicating a selection of Good Product from the two-by-two matrix of FIG. 11. Entry of a selection may be performed by tapping, clicking or otherwise selecting one of the icons 1106, 1108, 1110, 1112 and selecting a Next button 1114 in screen display 1102.

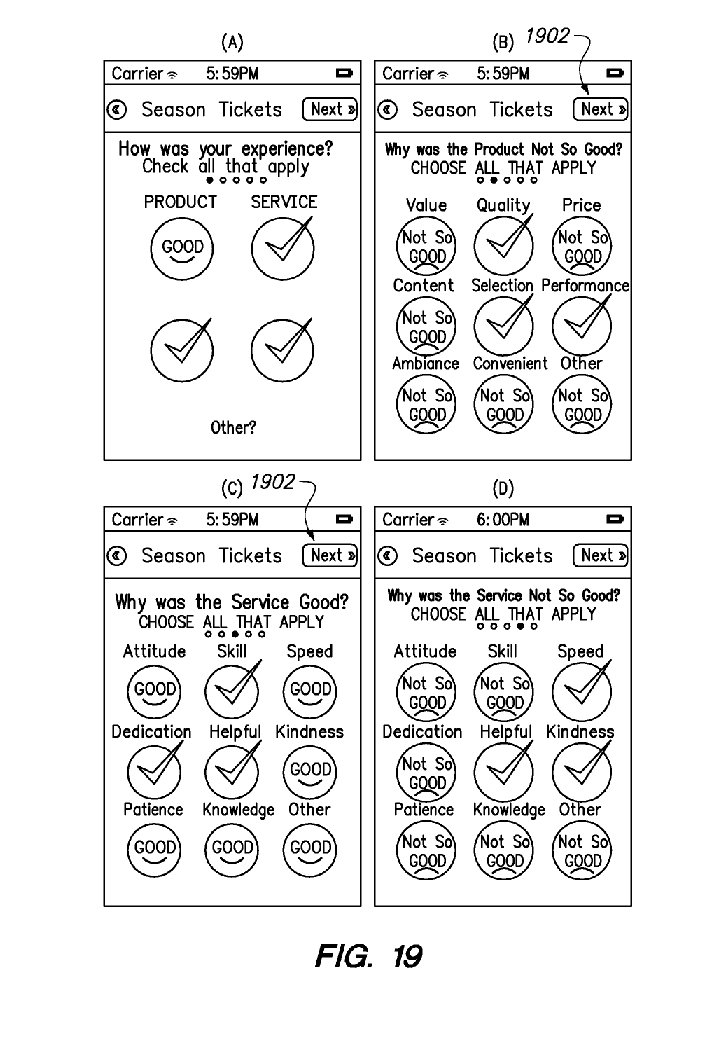

In an embodiment, selecting one of the icons 1106, 1108, 1110, 1112 causes the app 11 to redisplay the icons with a different appearance indicating selection of the icons. FIG. 19 is a four-part view that illustrates first-level feedback prompts and three sets of successively presented second-level feedback prompts. FIG. 19 view (A) depicts an example in which the user has selected icons representing Good Service, Not So Good Product, and Not So Good Service. In response, the corresponding icons are redisplayed with checkboxes or other visual indicators that the icons have been selected.

At block 112, the process selects and causes displaying one of a plurality of second-level feedback prompt sets based on the first-level feedback data. For example, app 11 displays a user interface screen display that contains a three-by-three matrix of second-level feedback prompt options that are chosen based on the prior response of Good Product. Example options for a restaurant in which the product is a meal could include Portion Size, Taste, Presentation, Side Dishes and others.

FIG. 12 illustrates an example screen display comprising a three-by-three matrix of second-level feedback options that the user may select in response to a first-level selection of Good Product. In one embodiment, screen display 1202 comprises a matrix 1206 of icons 1208 that are respectively associated with second-level user feedback responses of Good Value, Quality, Price, Durability, Selection, Style, Performance, Innovative, Other. Other embodiments may use other arrangements of icons and other labels or content for responses. Each of the icons 1208 is configured as an active GUI widget which, when selected, causes communicating a corresponding response data item to the app 11 to be included in a record that is communicated to the service provider computer 14.

FIG. 13 illustrates an example screen display comprising a three-by-three matrix of second-level feedback options that the user may select in response to a first-level selection of Not So Good Product. Screen display 1302 comprises a three-by-three matrix 1306 of icons 1308 associated with the responses shown in FIG. 12 but associated with Not So Good Product. Other embodiments may use other arrangements of icons and other labels or content for responses. Each of the icons 1308 is configured as an active GUI widget which, when selected, causes communicating a corresponding response data item to the app 11 to be included in a record that is communicated to the service provider computer 14.

FIG. 14 illustrates an example screen display comprising a three-by-three matrix of second-level feedback options that the user may select in response to a first-level selection of Good Service. In one embodiment, screen display 1402 comprises a matrix 1406 of icons 1408 that are respectively associated with second-level user feedback responses of Good Attitude, Skill, Speed, Considerate, Patience, Accurate, Helpful, Knowledge, Other. Other embodiments may use other arrangements of icons and other labels or content for responses. Each of the icons 1408 is configured as an active GUI widget which, when selected, causes communicating a corresponding response data item to the app 11 to be included in a record that is communicated to the service provider computer 14.

FIG. 15 illustrates an example screen display comprising a three-by-three matrix of second-level feedback options that the user may select in response to a first-level selection of Not So Good Service. Screen display 1502 comprises a three-by-three matrix 1506 of icons 1508 associated with the responses shown in FIG. 12 but associated with Not So Good Service. Other embodiments may use other arrangements of icons and other labels or content for responses. Each of the icons 1508 is configured as an active GUI widget which, when selected, causes communicating a corresponding response data item to the app 11 to be included in a record that is communicated to the service provider computer 14.

The number and content of screen displays presenting second-level feedback options may be determined in part upon the first-level feedback data. For example, in FIG. 19 view (A) depicts a situation in which the user selected Good Service, Not So Good Product, Not So Good Service. In response, app 11 successively generates and presents three (3) screen displays prompting for second-level feedback and corresponding to Not So Good Product (FIG. 19 view (B)), Good Service (FIG. 19 view (C)), and Not So Good Service (FIG. 19 view (D)), respectively. Selecting a Next button 1902 in the first one of the second-level feedback screens of FIG. 19 view (B) causes generating the next second-level feedback screen in succession as seen in FIG. 19 view (C), and so forth.

At block 114, one or more second-level feedback data items are received at the computing device. For example, app 11 may receive one or more data indicating a selection of one or more options from the three-by-three matrix. Selections of multiple second-level feedback prompt options are permitted in some embodiments. For each of FIG. 12, FIG. 13, FIG. 14, FIG. 15, entry of a selection may be performed by tapping, clicking or otherwise selecting one of the icons 1208, 1308, 1408, 1508, respectively and selecting a Next button 1204, 1304, 1404, 1504 respectively in screen displays 1202, 1302, 1402, 1502 respectively.

At block 116, if the first-level feedback data indicated “Good Service,” optionally the process causes displaying a prompt to enter a staff identifier and comments. The staff identifier indicates a particular person of the business entity that the user wishes to identify for specific comments about good service. In an embodiment, the staff identifier may be selected using a pull-down menu GUI widget generated by app 11 that is pre-populated with identifier of specific staff members based on an API call to the enterprise computer 16 or the service provider computer 14. Additionally or alternatively, the GUI widget may comprise a text entry box in which the user can enter a name or other identifier of the staff member. In some embodiments, the GUI widget or screen display provided by app 11 to implement block 116 may be styled as a HEROMAKER service, as further described herein.

At block 118, optionally the process causes displaying a comment input field and receives user input specifying comment text about the business entity. Displaying the comment input field may include displaying a sharing option as seen at block 118a and/or favorites or shortcuts as seen at block 118b. The sharing option may be configured to receive user input indicating whether the user's comments can be shared directly with the business entity. The favorites or shortcuts may be configured and provided using predictive techniques as further described herein.

FIG. 16 illustrates an example screen display that may be used to obtain comment input. In an embodiment, app 11 generates a screen display 1604 as part of processing at block 118. In an embodiment, screen display 1604 comprises a comment field 1606, sharing option 1608, favorites option 1610, recommendation widgets 1612, and send button 1614. In an embodiment, the comment field 1606 is configured to receive text input of a comment that the user wishes to associate with a feedback record. In an embodiment, sharing option 1608 is configured to receive a single tap, click or other selection to indicate whether the user consents to sharing the comments via publication in third party data sources. In an embodiment, favorites option 1610 is configured to receive a single tap, click or other selection that causes automatically displaying a set of links, icons or widgets associated with predicted responses or common responses for the associated business or for the user. Obtaining data in response to the use of favorites option 1610 and providing the data in reports to enterprise computer 16 may help give the enterprise a structured profile of what is important to a consumer. For example, data analysis processes can provide business intelligence to a business on what a consumer values even if the consumer does not enter text comments about particular values for a specific business. As a result, a business receiving the information may be able to identify new product ideas based upon the responses that indicate favorites of consumers.

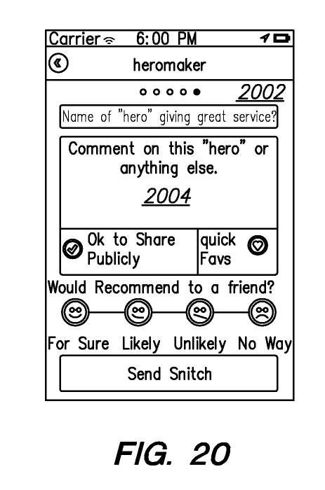

FIG. 20 illustrates an example graphical user interface that may be used to obtain feedback input for a particular individual associated with an entity. In the example of FIG. 20, a personal identifier field 2002 is configured to receive user input specifying a particular individual in the business such as a server, staff member, manager, or other person. Comment field 2004 is configured to receive text comments about that person or any other subject matter. Entry of values in fields 2002, 2004 results in association of the values with a data record for the user's responses to enable the business to obtain reports or receive analyses relating to the person identified in the personal identifier field, as further described herein.

At block 120, the process receives user input indicating a value based on Net Promoter Score® (NPS) theory. For example, the user input may comprise a response to a prompt of “How likely are you to recommend this business to others?” In some embodiments the value may be selected according to a rating scale using numbers, stars, or other indications of the strength of a response. Referring again to FIG. 16, in an embodiment, recommendation widgets 1612 comprise a plurality of active icons, buttons or other GUI widgets which enable the user to provide a recommendation response. The plurality of items in widgets 1612 may be arranged in a hierarchy or scale of ratings, strengths, or other measurements that indicate varying degrees of recommendation or other response. In some embodiments, widgets 1612 provide a means of collecting an NPS value.

In an embodiment, selecting send button 1614 causes the app 11 to form a message, response or other communication to the service provider computer 14 that can be used to form a record for storing in data repository 22 to associate all previously entered values with metadata values. In block 122, the process creates a data record that associates values for a user/customer/account, time, place, the first-level feedback data, the one or more second-level feedback data items, the comment, and the NPS input value. In block 124, the data record is communicated to one or more server computers, such as one or more of the service provider computer 14 and the enterprise computer 16. In this manner, the NPS input value becomes associated with the first-level feedback data, the one or more second-level feedback data items, as well as time and place information to provide valuable feedback to an enterprise in connection with an NPS value.

At block 130, one or more data analysis and reporting operations are performed. For example, processes at service provider computer 14 may aggregate, correlate, or otherwise analyze a plurality of data records received via block 120 from a large number of computing devices 10 and produce new values based on the data that indicate trends, scores, or other analytics. As one example, service provider computer 14 may determine a percentage or number of responding computing devices that provided each possible first-level feedback response as well as each possible NPS input value. Additionally or alternatively, service provider computer 14 may determine the percentage or number of responding computing devices that provided a particular second-level feedback data item in combination with each possible first-level feedback response and each possible NPS input value.

The interaction between the consumer and business described for any of the foregoing embodiments, which may occur based on real-time data that is unfiltered in whole or in part, may foster consumer loyalty to the business, such as by empowering consumers with a voice that the business may indicate has been heard by the decision makers of the business. Accordingly, embodiments may provide a feedback supply system. That is, embodiments may provide consumer feedback that is pushed from the consumer, rather than consumer feedback that must be pulled from the consumer. Consequently, businesses may be invited to participate in the system of embodiments based on feedback already entered with regard to those businesses, which may increase participation of businesses in seeking consumer feedback.

Embodiments may provide a destination, hub, and/or clearing house for receiving, tracking, and analyzing business intelligence data. Unlike current systems, which merely collect unstructured feedback data, embodiments involve all types of business intelligence data. The business intelligence data may be gathered using an interactive approach to questioning. A subsequent question may be based on an individual's response to the previous question. Therefore, the system allows for great variation of data and feedback gathered among different individuals.

Through the interactive querying of individuals (consumers, employees, members of any business or organization, etc.), enormous amounts of business intelligence data can be accumulated. For example a user (a customer, for example) may have only answered a few questions, but the system is able to inferentially learn vast amounts of other information, simply based on a few selections by the user. Simply put, the system not only learns from what a user has selected or answered, but also from what the user has not selected or not answered. Therefore, seemingly hundreds of questions worth of information can be gathered and analyzed in seconds. Feedback may be qualitative and quantitative, and may be linked and indexed, such as based on identity of user or computer, feedback history, frequency of feedback, feedback in particular verticals, and the like.

The data collected may be qualitative, quantitative, and more objective, and thus less subjective than in prior approaches. For example, feedback may be segmented, such as through the use of one or more hierarchical screens, as will be discussed further herein below. A consumer may be presented with a series of screens providing the consumer with options to provide feedback on various aspects of a particular business, the first screen of which may be in the form of a grid (e.g., a 2×2 matrix) based on the number of feedback options presented. This first screen may provide options, such as good or bad, and for a product and/or service. A subsequent screen may provide the user with further options for providing feedback, and these options may thus be based on the feedback given in the previous screen. In other words, options on subsequent screens may hierarchically progress to build upon the options presented and selected on a previous screen. Moreover, the responses available in such a format allow for an inferential response to other questions, thereby exponentially increasing the business intelligence data that is available. For example, the selection of good and service is a counter-indicator for all questions that might have been posed with respect to bad and service.

The size of the grid of the subsequent screens may vary based on the number of options presented to the consumer. For example, a user may be provided with a 2×3 grid, i.e., a six choice, subsequent feedback screen, based on the selection of particular feedback, such as good feedback, for, for example, a product on a first provided grid screen. Data entry to the grid may be, for example, via click, touch, voice command, or the like. The objective, binary data entry may be performed as a grid data entry of any size grid, such as two-by-two, two-by-three, three-by-two, three-by-three, four-by-four, or the like, and other than a two-by-two grid may be most preferable for screens subsequent to the primary feedback screen. The presentation of subsequent grids may be influenced by responses in previous grids, and likewise, initial and subsequent grids may be influenced by other factors over time, such as user history as discussed further throughout. In an embodiment, obtaining responses via each additional screen exponentially increases the data points that are available for analysis without a corresponding increase in user time requirements. Any of the grids or input screens may comprise content that is determined in part based upon geo-location information, such as latitude and longitude values, for a mobile computing device that is used as computing device 11.

Using dynamic grids allows for an appreciable decrease in the amount of time that a consumer dedicates to providing useful responsive data. For example, embodiments may provide increased usability of data obtained, and may obtain the data faster than such data is obtained in the prior art. This drastically increases the number, depth and quality of responses provided in embodiments, and substantially decreases negative skewing. Also increased is the number of repeat reviewers, and the capability for, for example, trending and time-based series.

By way of non-limiting example only, a consumer may be sitting in a coffee shop enjoying a cup of coffee she just ordered. Very shortly thereafter the consumer may be presented with a first screen (e.g., a two-by-two matrix of choices) inviting her to give feedback on the coffee and/or service she has just received. Based on the consumer selecting “good” and “product,” for example, the consumer may then be presented with feedback options reflecting different aspects of the product, in this case, the coffee (e.g., temperature, bitterness, sweetness, flavor, and the like), that the consumer may have liked. On the other hand, if the consumer selected good and service, the consumer may be presented with entirely different feedback options reflecting different aspects of the service, which may include, for example, timeliness, courteousness, accuracy of the order, and the like.

The level of customization and business intelligence data accumulated is thus greatly enhanced, as the system may also take into account other factors, such as time, location, language utilized, employees or customers involved, employee or customer demographics, and the like. Accordingly, and in part through data sorting capabilities of the system, a few actions (or clicks, for example) by a user in the system may result in the generation of different data sets being dynamically presented and compiled, thus allowing an exponentially greater amount of business intelligence to be attained.

Accordingly, not only may objective feedback be provided on a second or subsequent screen in a grid-based objective feedback system, but additionally surveys or similar questions may be provided as part of a grid, such as at the request of a business, on a second or subsequent screen, without the appearance to the consumer that a survey is provided. For example, one of six choices on a second or subsequent screen may include brand identifiers, i.e., descriptive terms, that the company deems most relevant to the company. Embodiments may employ keyword searches of accumulated data, such as by any party granted access to the data, which searches may qualitatively supplement, at any point, the objective binary quantitative information. Frequent selection of these choices by consumers will indicate that consumers do, indeed, identify the brand as the brand sees itself. However, should consumers make other choices, or not choose the company's brand identifiers it may indicate to the company that consumers do not see the company's brand as the company itself sees its brand.

By providing real time business intelligence data, embodiments allow for a variety of sales leads, including invitations to loyalty members, invitations to join loyalty programs, targeted marketing, real-time correction to issues in service, or the like. Embodiments allow for interaction with existing business loyalty programs. For example, instead of an airline customer having to complete a lengthy survey, or obtain employee recognition forms, the customer can use a mobile computing device to rapidly contact the system and provide feedback.

Specialized feedback may be provided in accordance with such a system, such as in conjunction with feedback commentary provided on latter screens, which commentary may typically constitute the entirety of feedback in the prior art. For example, the objective data entry by a consumer may allow for improved subject data entry subsequent to, or based upon, the objective data entry.

In embodiments, grid-based first-level feedback data may allow for the selection of good or bad with respect to a service and the selection of good with respect to service may allow, such as on a second or subsequent screen, the entry of particular commentary with regard to why the service was good, or, more particularly, who provided the good service. In an embodiment, the user may nominate a particular service provider as a HERO for having provided exceptional services. In an embodiment, on a comment entry screen, testimonial video may be provided, such as by the consumer, indicating a uniquely exceptional experience with the particular service provider identified as HERO. In this manner, embodiments provide an efficient mechanism of objectively capturing why service is good, if service is good, or an identity of the provider of the good service, as a consumer is experiencing the service at the location at which the service is provided. The type and prompt nature of this feedback may enable an organization to more effectively encourage desirable employee behavior by, for example, rewarding the employee who has been identified as the hero. Additionally, the HEROMAKER service provided in an embodiment may allow for an employee to hold a reputation portfolio indicating the frequency with which the employee has provided exceptional service.

In some embodiments, the enterprise computer 16 may communicate feedback from the business entity to the customer through mobile app 11; for example, the enterprise computer could communicate a message of thanks, a reward, or other recognition of the value of the customer to the business. In an embodiment, such a process may be branded or termed a REVERSE HEROMAKER process. In this way, an organization may recognize the positive impact a consumer has on the organization. This recognition may lead to increased consumer loyalty and affinity for the organization.

Using these processes, a business may be able to quickly attain testimonials based on, and/or tailored to particular attributes the member business may wish to highlight. In an embodiment, the testimonial information may be offered for purchase by the business from the service provider computer 14, providing the opportunity for rewards or sharing by the intermediary of the proceeds of such a purchase by the subject business, for the consumer who generated the testimonial.

In an embodiment, the system herein may allow for the entry of commentary or subjective feedback, in conjunction with objective feedback, in a variety and manner and for a variety of uses. For example, the grid, or matrix, objective feedback discussed herein may be modified based on, for example, an SIC code of a subject business in which the consumer is then located and with regard to which the consumer is providing feedback. The ability to enter commentary may be varied in accordance with the objective feedback provided. For example, key word search strings of certain types may be particularly relevant to certain types of businesses. For example, the commentary feedback discussed herein may be particularly relevant to certain types of businesses, particularly from the standpoint of using such testimonials in subsequent advertising, and/or to assess particular employee performance.

In an embodiment, businesses may be provided with data relating to employee performance. Employee recognition and aware programs may be based on objective data received from consumers. The business entity may provide feedback to a placement service about the success or reputation of an employee for whom the business paid a placement fee to the placement service, based upon feedback data received through embodiments.

In certain embodiments, still images, video, audio, or other file attachments may be added to a feedback record. For example, a user may assess the service in providing coffee as good, but the coffee provided was bad, and may state in the commentary that coffee has an odd colored and has an odd taste. In accordance with this comment, the user may attach a picture of the coffee having an odd greenish color, along with the user's objective comments.

The HEROMAKER process described herein may allow for distribution of feedback data or reports. For example, a business may enhance its reputation by stating that seven persons identified using the HEROMAKER process work at the business, or an employee may enhance his or her reputation by stating that he or she has been identified using the HEROMAKER service fifty times. Moreover, a business may use such information to assess who the best employees of the business are, that is, who are the employees that provide the best customer service whether or not the employer is watching.

In certain embodiments, a question based upon Net Promoter Score® theory may be obtained, as previously described. In various embodiments, the answer could be a binary “yes” or no” and may preferably take the form of a sliding scale. Such a scale may be sliding and may take a number of forms, including a sliding feature operable by a user and spaced between a “No” and a “Yes” value. A numeric scoring mechanism may be used.

In an embodiment, the approaches herein enable improved data analysis of the feedback data. In an embodiment, the use of at least two types of feedback data may allow businesses to distinguish what is driving consumer feedback for new or frequent customers.

In an embodiment, data collected from users may be mapped and or mined using software and hardware to reduce the spoken words to sortable structured data. In such an embodiment, verbal-based data, such as answer to telephone posed questions, such as in a survey, for example, may be linked to the two-by-two and three-by-three matrix solutions.

Embodiments may provide data from service provider computer 14 to enterprise computer 16 directly, in response to a request from the enterprise computer, and in whole or in part. For example, data not requested by the enterprise may be directed to the enterprise via email, a link or other invitation, to an account in a third party communication service, or to a page in a third party social networking service, with payment or without payment. For example, the service provider computer 14 may post feedback to a business's Twitter account, Facebook account, or the like, at no charge. Additionally or alternatively, service provider computer may send data, to an email address, or via a report.

In some embodiments, a business may configure service provider computer 14 to provide data to specified persons at specified times. For example, a particular manager among a plurality of different managers of a restaurant may be provided with feedback while that manager is managing the restaurant that night to facilitate addressing issues as they arise. Similarly, in taxonomy, the data may be parsed and directed to the individuals responsible for the subject area; this is a time consuming and delayed process with unstructured comment data.

In an embodiment, a business may pay to obtain additional feedback. For example, a subsequent three-by-three grid screen display may be added to app 11 to prompt for feedback about which products a customer cares most about.

Embodiments may also provide the ability to individually select certain fields in app 11 and create a custom survey. For example, service provider computer 14 may provide a configuration interface that a business user may access to select fields that will be displayed by app 11 when the customer requests to provide feedback for the business. In some embodiments, tailored surveys and other information may be used for a plurality of similarly situated businesses that are independently owned or operated. For example, levels of customization may enable a business to pinpoint exactly what products and/or services a customer is most concerned with, and, in turn, allow businesses to focus on these particular products and/or services.

It is widely known that the development and launch of almost any new product or service carries a considerable amount of risk. Indeed, in view of the on-going dominance of the existing brands, it has to be questioned whether the risk involved in most major launches is justifiable. Embodiments may help to lower that risk.

As an example, a multi-site store may have business intelligence data according gathered and analyzed by our system, which includes structured business intelligence data gathered from some of, in not all, of their other sites. As a result, the business may take advantage of this multi-site data to efficiently experiment to gauge the viability of a product or service in a mass market prior to a wide scale roll out, akin to a test market. This way, businesses may gather very meaningful new data. For example, the structured data gathered by the system may aid the business in effectively making decisions concerning the test market (e.g., which test market, what is to be tested, the duration of the test, success criteria, and the like). Simply put, using the structured business intelligence data according to the system of an embodiment, business are able to efficiently and more effectively make business decisions to increase the success rate of the development and launch of products and services.

Embodiments may also include a social media integration component, which may allow for targeting marketing, such as wherein celebrities customize queries to create questions for fans. For example, a Star Athlete may create a set of first-level feedback prompts and second-level feedback prompts asking his fans to comment on what pair of sneakers he should wear for his next game. Consistent with the learning behavior of all other aspects of an embodiment, a next question may be asked based on the fans answer to his previous question, such as “what would you pay for the model shoe that you've selected in a retail store?” Embodiments may also include stadium or theater use of this type of real-time voting system where users give feedback on product options presented on in-stadium or in-theater multi-media display systems such as, for example, an in-stadium Jumbotron or on a movie theater screen.

For non-member businesses, the aforementioned Twitter or Facebook-based feedback provided may further constitute an invitation to the business to join the system of an embodiment. For example, general feedback may be provided to a business's Twitter account, but testimonials may be made available to the business only upon the business registering for the services of an embodiment.

Likewise, the grid based feedback discussed herein may allow for businesses to have different levels of membership. For example, two-by-two feedback may be provided to member businesses for free, but feedback in broader or subsequent to the primary grid may be provided to business for a charge. In an embodiment, businesses may be charged, for example, for insight into custom identification of those who provide feedback. For example, loyalty program members may be more highly valued by a business with regard to feedback. In an embodiment, a business may increase loyalty program membership via a capability to recognize when feedback is being provided by non-loyalty member customers. A loyalty, or “favorites,” designation may be based on, for example, how frequent, or active, a customer is with feedback with respect to a certain business, or a certain type of business, such as may be ascertained by a business's NAICS code or SIC code. These “favorite” customers' feedback may be weighted differently than non-favorite (i.e., non-loyal, or non-loyalty program member) customers. As such, a business is better able to understand unique product and/or service features that are foremost in the mind of the most highly valued customers. It is also important to note that, these same highly valued customers are unlikely to be inclined to take repeat business generated surveys that are not specific to their particular, and sometimes unique, needs.

The data accumulated using embodiment is new and previously unavailable. For example, brand identity may be indicated through the use of an embodiment, such as via the herein discussed survey mechanisms on a second or subsequent screen. As such, a business may use an embodiment to assess brand identity and brand value of the business. For example, a business may choose to include its brand identity in a subsequent grid feedback choice. To the extent consumers frequently pick that feedback choice, the business will have received an indication that is has a proper brand identity. In an embodiment, grid data entry may allow for conclusions to be readily made, such as with regard to aspects unique to particular consumers. For example, certain customers in certain demographic groups may consistently focus on different aspects of product or service offerings in a way that is difficult to ascertain by current survey means. Specific data according to certain demographic groups may be tabulated and/or tailored for multi-site customers to enable a business to better understand variations by region, subregion, zip code, across competitors, across related business types, and the like.

In an embodiment, true 360° feedback may be available continuously via the use of an embodiment, wherein feedback internal to a business, internal to a supply chain, from employees to a business or to affiliates, within affinity groups, within development teams, within departments, within governmental, educational, or similar large entities, as well as from consumer to business, may be obtained. Of particular note, embodiments may be employed on a global scale. Specifically, feedback may be associated with any of the aforementioned entities, regardless of the location (national or multinational). Moreover, such data may allow for the use of an embodiment to obtain sponsorships and/or targeted marketing, such as based on brand identifiers, user preferences, or the like. In an embodiment, data may be accumulated in a number of ways, such as via a mobile app, a thin computing device 10 (such as a browser), an on-site interface, or the like. Moreover, data may be accumulated in any number of languages through the use of an embodiment, such as based on known preferences of a user based on geo-location, user selection, user profile, in-app user history, and/or device-based preferences as indicated by on-board mobile device information. That is, as illustrated and discussed below, any one or more of the screens provided for the substantially objective feedback system of an embodiment may be provided in English or any other language.

The multilingual aspects of an embodiment may also provide unique data features. For example, the multilingual feature may indicate that Spanish customers typically provide statistically worse reviews than English speaking customers. As such, a business may be informed it needs to improve its customer service to Spanish speaking customers.

Thereby, an embodiment includes data, such as hard data, feedback data, testimonials, and the like, that may allow for a value assessment of brands, people, consumers, etc. In an embodiment, this value assessment may be provided through the use of an embodiment throughout companies, throughout chains of service and supply, and the like. In an embodiment, because the feedback that generates said data is provided at least partially objectively, and may begin at the level of the consumer, the data of an embodiment is a more true indicator of a value than can be provided using the data available in the prior art. Moreover, through the use of the hero maker discussed herein, improved supply chain feedback may be available, particularly with regard to embodiments wherein multiple suppliers may give feedback on one another, and may particularly point out exceptional service as between service providers. In an embodiment, employees may comment on products provided by different suppliers, thus enabling businesses to make more intelligent business decisions with regard to suppliers, which is also not captured in the available art. In an embodiment, third party consumers may comment on frequent business service providers such as sales representatives in a custom closed network.

Additionally, the use of an embodiment may allow for highly individualized feedback data, and consequently for highly individualized feedback data entry. For example, a user profile of the consumer may be generated over time, which may indicate, for example, that a user has certain preferential products or services that the user likes to give feedback on, and/or that the user prefers to give feedback in certain terms. For example, the user may typically like to enter feedback with regard to children's products, thus indicating that the user is likely to have young children. As such, the user may wish to make feedback using this user-centric option based upon whether a product was good for the user's children, or whether a certain company provides products that are typically good or safe for children. As such, the user may be provided with an efficient feedback interface (such as the aforementioned grid interface) based on that user's history and/or known preferences, wherein the user may enter, in a single screen, objective feedback with regard to that which the user cares most about, such as products related to children in this example.

Binary-type data entry of an embodiment allows for real time trending, time of day ratings, or the like, which data may be simplistically, such as graphically, provided the consumers, even in embodiments wherein the underlying hard data is not to be available to consumers (i.e., certain types of data may be subject to various permissions in an embodiment). A scoreboard may allow users to find highly rated businesses in their vicinity, future vicinity, or by name. Because these ratings are done on a consistent platform across a wide customer set, the resulting accuracy is improved. The scoreboard also allows a user to isolate particular characteristics that are of particular importance to the user. For example, a budget conscious consumer may wish to sort, such as by location, a type of restaurant and a value rating. For example, a user may use a mobile app associated with an embodiment to be provided with a score board, wherein the user may be provided on the scoreboard not only with information with regard to restaurants, such as if the user is a “foodie,” but additionally may be provided with information regarding gluten free restaurants, because gluten free may be a known preference of the user based on prior comments and/or prior data entry. This type of high quality, high precision consumer feedback is not available through current feedback techniques particularly in applications related to apparel, health, beauty, and the like.

More particularly, the structured data accumulated in the present system may allow for specialized queries not available in the prior art. For example, a consumer may wish to search for a good Indian restaurant, with “not too spicy” food, within 15 miles of the user. If the grid choices on the initial screen include good product, and for subsequent screens provided particularly for Indian restaurants include that the food was deemed good because it was “not too spicy,” and the use can be geo-located or be allowed to enter a location, the aforementioned query can be satisfied by an embodiment.

An embodiment additionally allows for accumulation of data based on geo location, and thus based on providing feedback based on geo location. More particularly, for example, a user may attempt to enter feedback, wherein the user's geo location is assessed and the user is asked to enter feedback for the location at which the user is then-located. Alternatively, the user may be provided with, for example, a drop-down or like menu of locations near the user, or of locations near the user for businesses in a certain vertical, having a certain name, or the like, or of locations frequented by the user, by way of non-limiting example.

Accordingly, the objective feedback of an embodiment may not only provide an indication that a particular restaurant in Radnor, Pa. is very well reviewed, but may additionally provide an indication that a large number of reviewers felt that the experience was so good that they reviewed the restaurant positively while seated in the restaurant. As such, this very highly valued, and unattainable in the prior art, feedback may additionally be obtainable from consumers based on geo location in an embodiment.

This geo-located feedback may also greatly improve the ability to obtain geo-based reviews of businesses. For example, a user may go into a feedback screen, wherein the user may be asked if he or she wishes to see feedback of a location at which the user is then present. Likewise, and as discussed above, the user may optionally be able to select a certain nearby business, a certain nearby type of business, businesses nearby having a certain name, or the like. In an embodiment, the timeliness of data entry to an embodiment allows for particularly valuable information to be provided to the consumer. For example, the user may be able to see that a particular restaurant receives poor reviews between 6 and 7 p.m. but that the reviews improve drastically after 7 p.m. As such, the user may assess that the restaurant should be avoided until the service crew changes over at 7 p.m. In an embodiment, the restaurant itself may recognize that its staff present prior to 7 p.m. may need instruction with regard to improving customer service. In an embodiment, feedback may relate to particular members of the staff, as may be assessed by the aforementioned time stamp of the data. For example, in the foregoing restaurant example, if the restaurant receives particularly bad feedback between 6 and 7 p.m. on four specific days each week, and two staff members work each of those four days from 6 to 7 p.m., it may be an indication that those two staff members are providing particularly bad customer service.

Currently, many businesses, directly and indirectly, profit from a customer's personal data. Some Internet companies are increasingly moving to maximize profits from the vast amount of personal data they have amassed in their global network of servers. However, embodiments allow consumers to more directly profit from personal data, (e.g., feedback and preferences). By establishing a robust profile of the user that will be attractive to businesses, and that is built with the user's full knowledge (since the use is providing feedback data knowingly, and that data is building, at least in part, the user profile), embodiments enable consumers to be rewarded directly for their unique personal data. An embodiment may incentivize feedback, such as by offering “points,” cash, or like rewards in exchange for entry of feedback. For example, testimonial video, audio, or text may be particularly valuable to certain businesses. As such, those businesses may pay a substantial amount to the provider of the system of an embodiment to obtain those testimonials. As such, a user may receive rewards points for entering a testimonial, such as meeting certain verification criteria, to the system of an embodiment. For example, the user may use such reward points to obtain goods or services, or may indicate that the awards points be converted to cash, such as for a donation to a favorite charity. Thereby, increased submission of feedback in accordance with an embodiment may provide for increased amounts of rewards and direct benefits to the consumer, as opposed to that lack of benefits provided by businesses like some online Internet companies, for instance.

In an embodiment, rewards, such as in the form of points or the like, may be awarded while a feedback-provider is still at the location related to the feedback. For example, if a user enters good and product, a subsequent screen may allow the business to provide a comment, such as in the form of a reward. Of course, the rewards granted may vary randomly, and/or may be based on the feedback provided in the preceding screens.

FIG. 3 illustrates an example log in screen for an embodiment. For users not already registered to use an embodiment, an embodiment may optionally provide a sign in/sign up option, wherein the user signs in for a first time and is automatically signed up to use an embodiment. In an embodiment, upon sign in, the user may be provided with a secondary screen, which may geo-locate the position of the user in an established business, or which may allow for the user to select a business, such as a business near the user. FIG. 4 is an example of a secondary screen, which may geo-locate the position of the user in an established business.

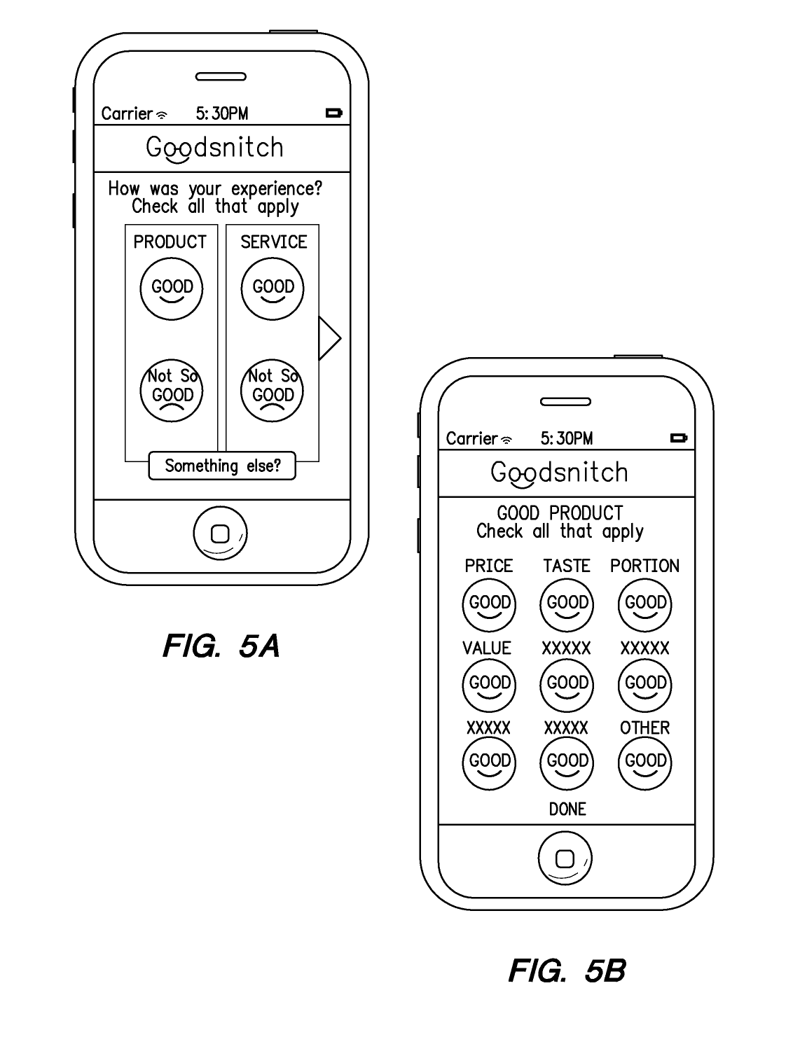

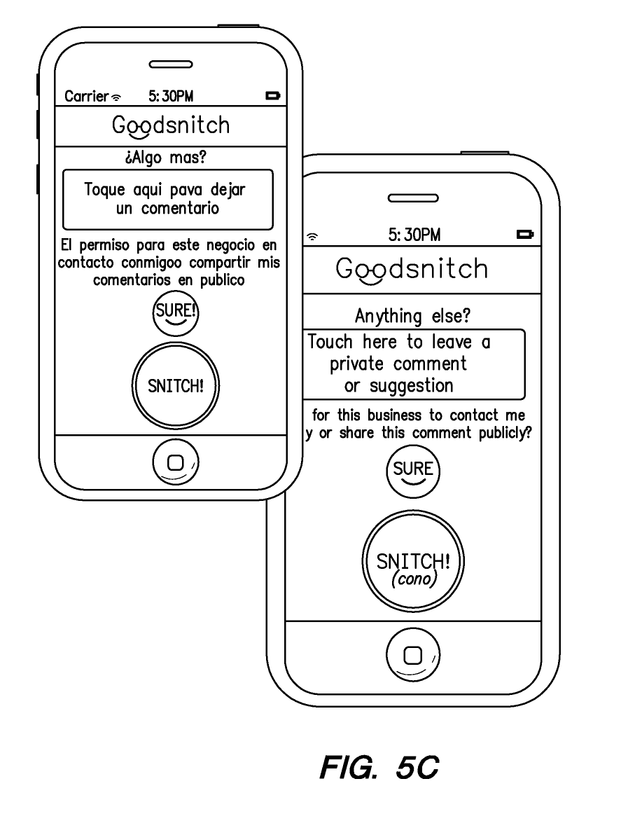

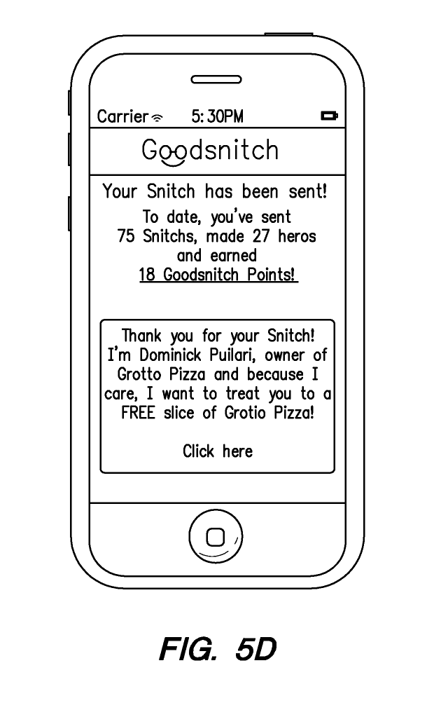

An embodiment preferably provides structured (as opposed to unstructured) feedback data, and provides increased objectivity in feedback over the available art. This is illustrated with particularity in the example embodiment of FIG. 5. As illustrated in FIG. 5A, a consumer is provided, such as upon request of the user to provide feedback, with a grid-based feedback system, comprising good and bad for both product and service. Upon selection of, for example, a good product, the user may be provided with the second screen of FIG. 5B requesting secondary, more particular, feedback. Specifically, because the user has identified the type of business, or the type of business is known based on, for example, a geo-location and/or an SIC or NAICS, and has placed the business feedback in at least one of the four initial major feedback quadrants of a grid (e.g., good product/service, not so good product/service), the nature of a subsequent three-by-three grid can be instantly varied to be more relevant to the type of business. For example, if an apparel store is selected and “good product” is then selected, the subsequent three-by-three grid query may include attributes related solely to apparel, such as assortment, style, fit, etc. These second order options may continue to be refined as customers select which items are those they care most about. In an embodiment, less frequently selected options may be replaced with more frequently selected options for all users over time, such as based on the increased business intelligence across the platform. In an embodiment, in this secondary screen and as indicated by the “XXXX,” a business desiring particular feedback may enter particular survey or brand identification choices for consumers that select, for example, “good” and “product” with regard to that business's product.

Subsequent choices available may be modified over time for particular users, such as to allow for increased efficiency of feedback. For example, if a user frequently reviews coffee shops, and over time shows herself to be interested principally in whether the coffee is served hot, that user, when deemed to be geo-located in a coffee shop, may simply be queried as to whether the coffee is hot.

More particularly, according to embodiments, the user interface screens may contain various other features enabling customers and other users to more easily provide, and businesses to more easily gather valuable feedback. For example, the screens may include “volume” bars that a user can slide up and down to more distinctly measure certain feedback given. For example, a volume bar may represent the intensity of a user's feedback. For example, the user may slide the bar up to express how strongly he or she feels about a particular concern, praise, or general comment. The volume bar may also reflect a comparative sentiment. For example, by sliding the volume bar up or down, a customer may be expressing how much better, or worse, a business's product is compared to other business's similar product. By way of further example, the volume bar may represent a user's sentiment relative to a previous sentiment pertaining to the same business. For example, by sliding the volume bar up, the user may be communicating that the service at a particular business was better than it was during a previous visit. Consistent with the highly customizable and learned behavior of an embodiment, the existence, size, and number of volume bars may depend on a user's answer to previous questions or feedback, other user history, and business selection, among other factors. Accordingly, the volume bars, over time, can impact the objective data and provide infinitely nuanced data analytics at scale. Also, it provides an improvement over the 1-10 ratings system by creating a fluid bar functionality that can be normalized at scale.

Other features enabling customers/users to more easily provide, and businesses to gather, valuable feedback are, in part, a product of the learning behaviors of an embodiment. For example, tools of an embodiment may remember the previous set of answers provided by a user at a specific location. This can result in the system providing auto-fill data, suggesting possible comments based on prior comments, providing favorite past comments options, creating three-by-three buttons using most frequently entered comments, adding possible keys, or the movement of the location of grid boxes based on the frequency of use. For example, more frequent user selections may be located towards the top of the screen.

Additionally, and as illustrated in the third screen of FIG. 5C, the user may be asked to enter unstructured commentary, such as that typically provided in the prior art. However, this unstructured data may be inter-related, such as via one or more relational databases, to the aforementioned objective, grid-based, feedback. In an embodiment, this commentary may be keyword searchable in addition to being tied to the objective data. Finally, entry of commentary data may include an ability to include additional data, such as entry of a hero maker testimonial pictures or video. This entry of additional data may be, for example, directly from a mobile device such as via the app discussed herein throughout.

As discussed throughout, an embodiment may increase the usefulness of data obtained, and the convenience for data provided, by operating using binary (such as the aforementioned grid-based) data sets. That is, data may be good or bad, for a product or service; good service may be friendly, fast, or highly competent; and so on. Thereby, data objectivity is better maintained than in the prior art. As used herein, binary data includes at least a limited subset of objective user selections, such as may be provided on a first and/or subsequent screens of a hierarchically organized user feedback entry system discussed above.

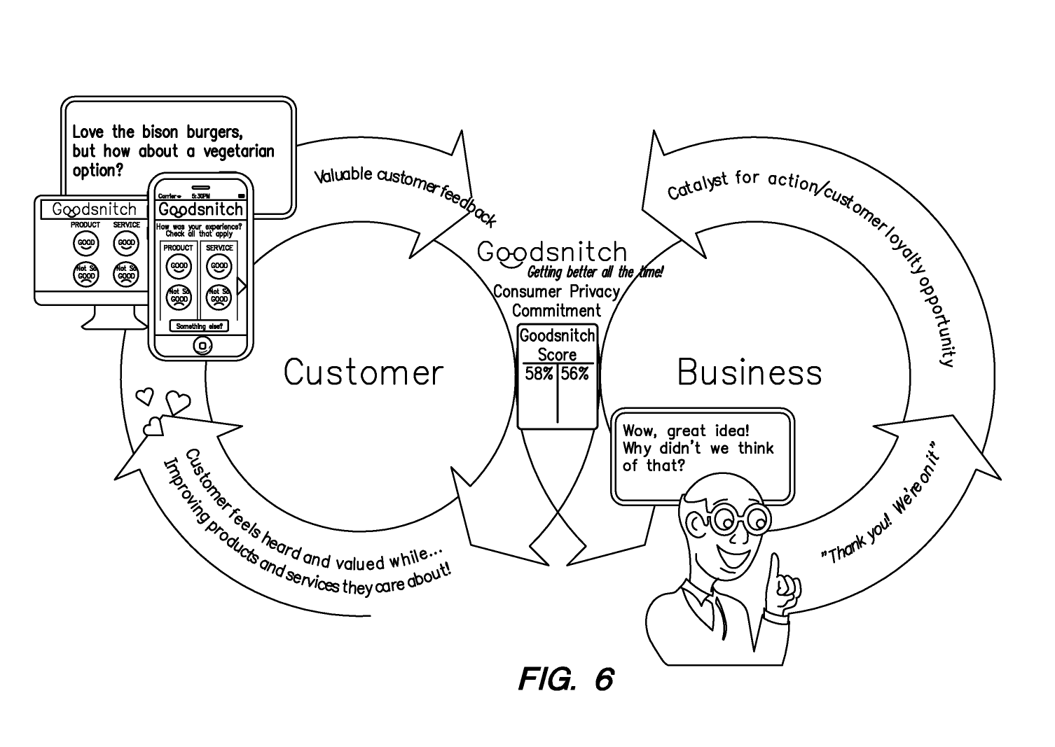

FIG. 6 illustrates an example data flow loop that may be used in embodiments. As illustrated in FIG. 6, a binary data universe allows for the efficient exchange of data between customers and businesses, or between different businesses, such as may be related in a supply chain. That is, the objectivity of binary data allows for increased efficiency in the exchange of feedback information to a business, and customer engagement and action based upon feedback to a customer. For example, embodiments include means to allow a business to provide auto generated immediate responses that appear to customer at the time a customer submits feedback. These responses can be tailored based on the customer's sentiments. For example, if the customer selects “not so good” service, an apologetic auto generated response may appear. For example, the response may read “[W]e′re sorry to hear that, and we greatly appreciate your feedback. Please come back and give us another chance to make your experience more positive”. In addition, such response, being generated in real time, could include an immediate store discount. In this case, the response may also recite, for example, “please accept this 15% discount as our apology, and please come again”. Such a positive auto-generated response, being delivered to the customer immediately, could reverse any potential damage to the relationship between the customer and the business; and, subsequently, reduce the likelihood, or opportunity, a customer may have to share his displeasure and complaints to others, whether by word of mouth, social media sites, etc. Due in large part to the binary structured nature of the data, these quick responses and/or actions mimic the actions a higher level supervisor might make had he the ability to be on site at all times, with knowledge of the opinions of each customer.

Moreover, the increased efficiency of an embodiment may stem from, by way of non-limiting example: the increased convenience and speed with which data may be entered, such as in 30 seconds or less or 60 seconds or less (thereby stimulating more feedback than is available in the prior art); the binary availability of providing feedback (i.e., feedback may be automatically available based on geo-location, and/or may be available for local businesses in a limited drop-down menu); and the greatly improved readability, searchability, and usability of a largely binary data set. The binary data may allow for the inter-relation between multiple sets of binary data to increase the readability, searchability, and usability of the available data. For example, good or bad product or service may be relationally assessed by location, by business name, by business type, or the like, and as such may be readily stored, tracked, searched, retrieved, passed to businesses, made available to consumers, or the like. Moreover, data security is increased by the simplistic categorization, and hence the ease of categorized data access, made available by such grid-based, largely objective data.

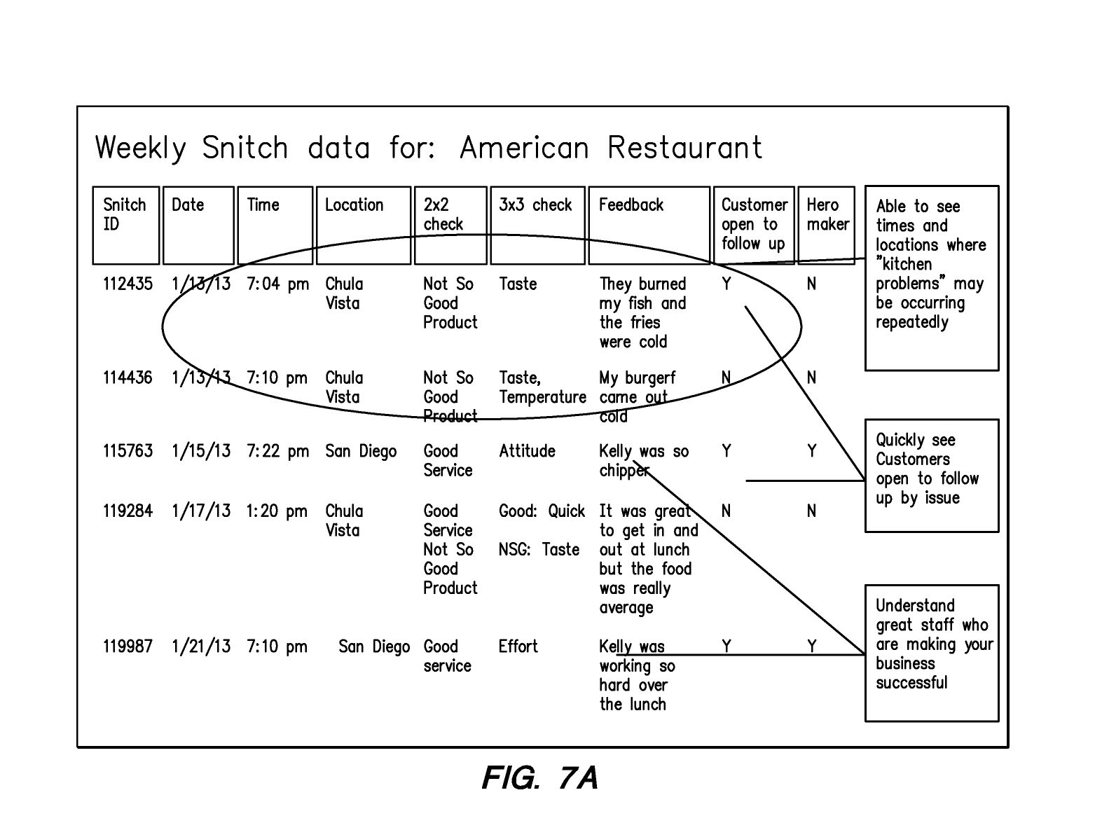

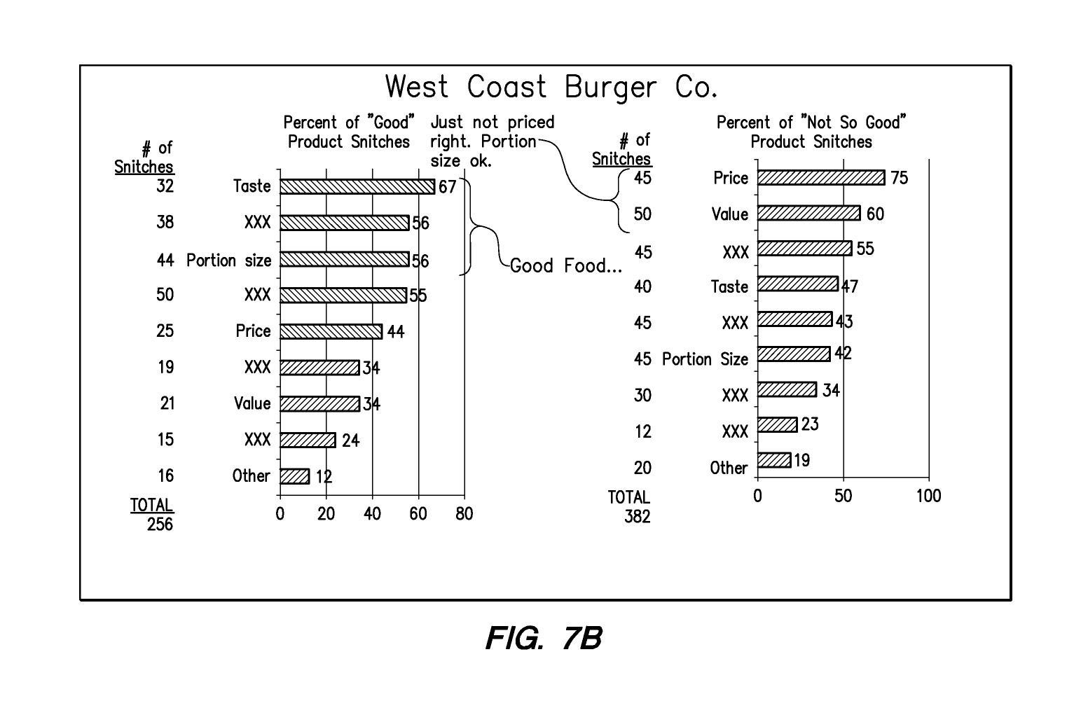

FIG. 7A is an example report of data values for a plurality of records received for a particular entity over time. FIG. 7B is an example analytical report that interprets data records of the type shown in FIG. 7A. As seen in FIG. 7A, FIG. 7B, the data repository 22 and reports from logic 20 may provide response data and also trend data or other analytics. Referring first to FIG. 7A, in one embodiment, a weekly data report for a particular entity (“American Restaurant” in this example) is presented as a table in which rows comprise data records and columns are values in the records. Each record comprises a unique identifier termed a SNITCH ID, and a date, time, location, two-by-two check value, three-by-three check value, feedback value, follow up flag, and HEROMAKER indicator. The two-by-two check value indicates a response to a first-level prompt, such as Good Service. The three-by-three check value indicates a response to a second-level prompt, such as Attitude, meaning that the user experienced Good Service as a result of employee attitude. The feedback value reproduces a comment that the user entered. The follow up flag indicates whether the user will accept responsive contact. The HEROMAKER indicator may be a flag indicating whether the user provided input on a particular service person or staff member.

FIG. 7B presents counts and percentages of data records for second-level data in association with first-level responses, organized in two charts. A first chart on the left side of FIG. 7B provides respective percentages different specified second-level responses, as represented by bars in the chart, that were received in records that had “Good Product” as the first-level response. A second chart on the right side of FIG. 7B provides respective percentages different specified second-level responses, as represented by bars in the chart, that were received in records that had “Not So Good Product” as the first-level response.

In an embodiment, trends may be assessed based on global data entry. Alternatively, a user may be asked for trend data with regard to a particular establishment, such as whether the user's experience was better on the current visit, or on a previous visit. In an embodiment, the strength of trends in the eyes of consumers may thereby be assessed, or the strengths of trends across consumers may be globally assessed. Of course, trend values may vary as compared to real-time snapshot data. This structured data and/or trends, according to embodiments, may also be applied across multiple businesses to allow for meaningful rankings of comparable businesses. These specific rankings may be an invaluable management tool for businesses, enabling them to understand more precisely their own or others' strengths and/or weaknesses, and are generally impractical to perform with unstructured data or data involving just one company

In an embodiment, the binary data provided by an embodiment may provide a basis for real time action by businesses to address consumer concerns. For example, a user may provide feedback from a seat at a restaurant that good service, but bad food, has been provided, at least in that the food was overcooked. This feedback may be provided in real time to the restaurant, and accordingly the restaurant may cook a new meal and provide it to the consumer while the consumer is still seated in the restaurant.

In other situations, the real time nature of the structured data may provide for helpful “early warning” signals to businesses about their own business or competitors. These warning signals may expose certain deficiencies, or blind spots, not readily apparent to a business absent customer initiated concern expression. For example, certain warning parameters (e.g. thresholds) may be specified by a business, which may allow for urgent emails or text messages to be sent to a manager when a series of bad scores, or bad feedback responses, occur. By way of example, if a restaurant has three bad product feedback responses within one hour, a manager may be messaged, and the manager may thus be able to timely address the concerns of a potentially unhappy customer, such as by immediately remedying (e.g., seasoning, temperature, etc.) the quality of food to meet the customer's expectations.

As noted above, early warning signals, as well as other embodiments and benefits of an embodiment, may be applicable to many types of industries. By way of further example, a customer may be shopping in a department store, and may be having difficulty locating a particular piece of merchandise. The customer may become increasingly frustrated if the customer cannot locate anyone for assistance. As such, the customer may submit a feedback response about the lack of service or employee availability, such as multiple times while she is in the store. These multiple feedback responses within a certain period of time may trigger a message to be sent to a supervisor who may not currently be on the showroom floor. Upon receiving this message, supervisor may immediately come out to the showroom floor and assist the customer in finding the merchandise they seek. Consequently, this immediate action may save a sale by locating the sought-after merchandise before the customer left the store in disgust and potentially believing the establishment simply did not carry the particular items which the customer sought. The ability to provide this feature dynamically and vary it for each industry and/or company type based on a key indicator of lost sales may be very beneficial to businesses.

Embodiments may be applied to any business, and not just retail (e.g., consulting firms, dentists, doctors, fitness facilities, etc.) Another example may be directed to a customer in the confines of his or her own home. For instance, an individual may be having issues with his internet service at home and is having trouble getting through to customer service to address a service outage. Oftentimes, customer service may not have the resources available to timely deal with the customer's service issues, and thus the customer may be put on hold for sometimes hours at a time. The system may be used to more efficiently deal with these customer service issues. For example, the customer could submit a feedback response which, according to the real-time nature of the system, could immediately alert management of the business to the customer's issue. In an embodiment, due to the progressive nature of our system, the system can quickly recognize a high volume of service problems in a particular location, thus effectively and timely pinpointing and addressing problems, without businesses having to spend countless hours with thousands of customers calling in with the same concern.

As the number of users and, in turn, number of feedback responses, increases, naturally more data is gathered, analyzed and sorted, and business intelligence is thus accumulated. Through the continued customization and learning of individual users' particular concerns, embodiments may tailor user feedback response experiences, and screen options based on his or her profile, thus allowing for even faster feedback response options, which may quickly allow a customer to communicate his pet peeves, for instance. For example, if a particular user is known to be handicapped, or is known, through his feedback responses history, to be particularly concerned with adequate accommodations at any establishment he visits, upon logging in to the system, the user may be more immediately presented with an option to provide express feedback response, thereby expressing to a particular establishment, his wishes that the establishment was more wheelchair accessible, for example.

With regard to the herein-discussed matrix, or grid-based, feedback, certain objectively-provided feedback may be user generated, and certain may be user identified. That is, all users may be asked for certain feedback, but, such as when particular users make similar comments regarding similar businesses repeatedly, a user may conveniently be provided with objective data entry mechanisms, such as buttons, that reference feedback frequently given by that user. For example, if a user enters the same term with regard to coffee in a commentary feedback more than three times, the user may be provided with a button that is labeled with that term from the commentary each time the user enters feedback with regard to coffee.

An embodiment may provide dynamic information, such as in order to provide a user the ability to renew a membership, make a reservation, or the like, such as from the app discussed herein. That is, such capability may be dynamically provided based on the objective user data entry. For example, if a user says the food was bad and the service was bad at a restaurant, the user may not, when nearing completion of the user's feedback, be provided with an invitation to make a future reservation at that restaurant.

For consumer based feedback, all consumers may be enabled to review aspects of, or all of, the feedback entered by other consumers. However, for business to business feedback, only certain persons may be enabled to see all or a portion of feedback given. For example, only Chief Executive Officers, Chief Technology Officers, etc., of a company may be enabled to review feedback regarding other companies in a supply chain. Accordingly, a CTO in a supply chain may be provided with information that people in the purchasing group of another member of the company supply chain are doing a great job. On the other hand, in some instances, for security or efficiency purposes, for only certain employees may see certain types of data. As such, embodiments may customize the routing of the structured data so that certain data is only available to certain individuals, excluding others who may be on a need to know basis.

Through the use of the real time aspects discussed herein, an embodiment may provide particularly valuable data. For example, if used in a classroom setting, students may be asked as to the quality of the providing of taught information, as well as of their understanding of the underlying information. A college professor may receive real time feedback as to whether the students understand complex information taught, or whether the professor could have taught the information to convey the information to the students in a more efficient manner. Likewise, feedback may be obtained, such as in real time, regarding video games, movies, or the like. Additionally, such as with regard to predictive sciences, questions may be crowd sourced, which necessarily will make the answers to the questions more statistically viable than is currently is available.

By way of additionally example of unique data provided via an embodiment, so-called “crowd-source” data may be provided via the use of the feedback systems and methods discussed herein. For example, a crowd-sourced, real time feedback for television programming may be provided through the use of an embodiment. Other uses may include, for example, co-location real estate predictive services due to the ability to look across users' feedback responses to detect correlations of business groupings where there are consistent affinities.

A particularly relevant group for certain embodiments concerns, for example, employees who may have strong feelings, or inside knowledge, about certain aspects of their employment or the business as a whole (e.g., concerns or suggestions for process/product improvement). An embodiment has the ability to vary the privacy settings of the user (e.g., employee) so that the user may be anonymous (e.g., for fear of backlash from his or her superior or peers). Alternatively, the user may wish to change the privacy settings to make her identify known to others in the industry, business, public, etc., so that she may be directly contacted by those interested in her feedback responses. These customized settings allow users to provide the most relevant feedback tailored to their own circumstances.

Additionally, an embodiment may provide significant business-to-business data value. For example, the location-centric services of an embodiment may indicate to a business where to put a new store, such as wherein users at a particular locale provide particularly positive feedback regarding that store's chain. In an embodiment, non-profit entities may be instructed by an embodiment as to knowledge of whom and where cares most about topics of importance to the non-profit. In an embodiment, an embodiment may provide information regarding feedback of competitors that are out-performing a subject business. Additionally, businesses may be provided with information regarding other companies that would make for promising co-location partners, merger partners, acquisition partners, joint venture partners, or the like.

Data in a user profile may be highly indicative of a normalized strength of a particular feedback review. For example, a user may provide, such as in a particular area, 90% negative feedback. As such, the 10% of the time in which the user provides positive feedback in that area indicates that the feedback is statistically significantly positive. In an embodiment, that user's “less negative” reviews may be the equivalent to positive reviews from another reviewer. Accordingly, an embodiment is capable of normalizing reviewed data, such as at the request of the receiver of the data.

In an embodiment of an embodiment, the systems and methods described herein may be utilized as a communication tool and may facilitate the structuring and management of various forms of communications simultaneously. For example, many of the described applications involve a new way to communicate and in a fashion that is more usable. For example, may be asked to “communicate” their thoughts on a new product, an issue, etc., but do it in a way in which they pre-place the communications into usable piles. Such a structure may allocate communications similar to the way votes in an election may be sorted out, automatically.

In an embodiment of an embodiment, a shopper in a store using a mobile application associated with an embodiment may utilize the application to locate a desired product based on various information sorts. For example, information may be gathered through a series of questions and/or in conjunction with the matrix solutions discussed herein. For example, the shopper may be at a retail store (and utilize a two-by-two matrix related to clothes), and may further inquire about what type of clothes (and utilize a three-by-three matrix related to Boys) and/or may further inquire about what type of boys clothing (and utilize a three-by-three matrix related to sweaters) and/or may further inquire about what type of key features (and utilize a three-by-three matrix related to items under $20 and red, for example). The mobile application may therefore sort and/or highlight specific product recommendations and assist with in-store location.

In an embodiment of an embodiment, each user may have a distinct profile which may include, for example, a reputation depository. Such a depository may be used to hold referral information and/or past work histories all key to a user specific address. As users hold jobs and/or gain work/educational experience, for example, evidence of such activities may be placed within the reputation depository. In this way users and other individuals associated with the activities of the user may deposit feedback into the user's reputation depository. As this reputation portfolio builds over time, it may be made available to third parties, such as future employers, for example, or other reference seekers. Such a transaction may also be done for a fee and/or in exchange for other information.

As discussed above, a user of an embodiment may provide feedback verbally using voice recognition technology, which may be done in a prompted and/or unprompted manner. Given the nature of speech and possible errors in receiving and/or digitally decoding sound, the user may be presented with the opportunity to review and edit such feedback and/or input as text. The ability to utilize speech may allow an embodiment to receive and process user input at a much greater rate than existing methods.

The use of speech, as well as with other forms of communication, may allow for empathetic feedback, for example. In this way, the received information may allow for the building of a direct, listening relationship between the business and the user, for example. The process of listening and potentially acting on the feedback may demonstrate that the business proprietor is empathetic.

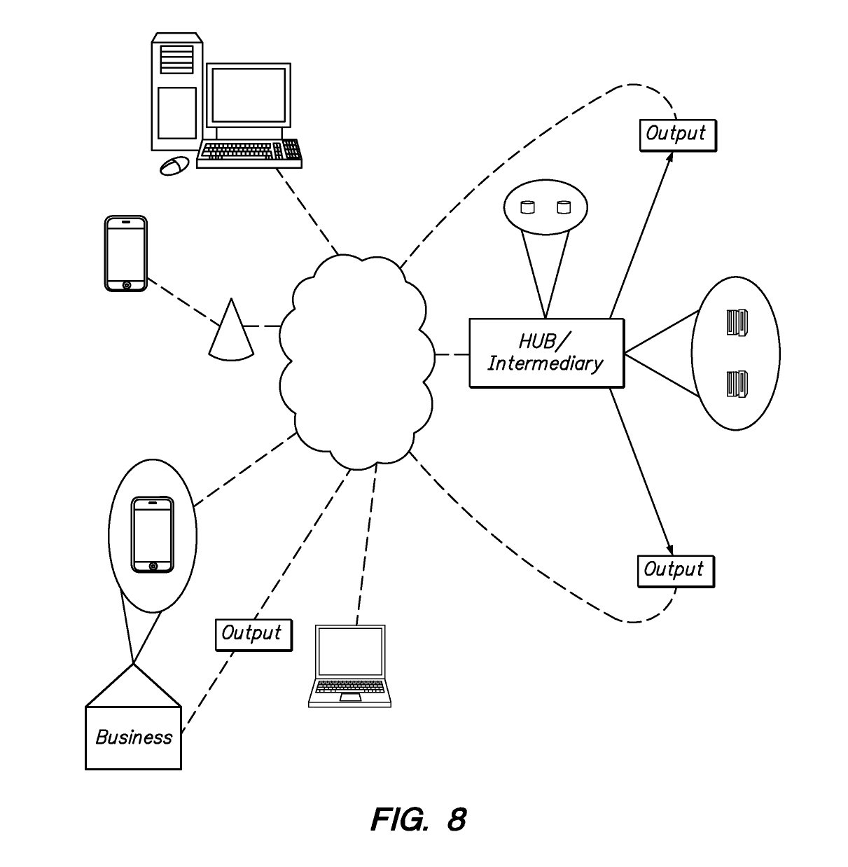

FIG. 8 illustrates an example computer system for one implementation of an embodiment. As illustrated, the system includes one or more data entry points, which may include, for example, mobile devices, desktop computers, or the like, and which may be at feedback input locations, such as in possession of a user, at a place of business, or the like, and which may be owned or controlled by one for more consumers, or one or more businesses. The input devices are connected, via a telecommunications network, to a central feedback hub. The central feedback hub may be, for example, one or more servers having associated therewith computer storage in which is stored one or more relational databases for accumulating the data discussed herein. The data may be provided over the one or more networks via, for example, one or more apps, applications, web browsers, or the like. The one or more relational databases may relationally store the data discussed herein. In an embodiment, as illustrated, the system may include one or more data output points.

Such data output points may include consumer outputs, such as via feedback scoreboards for businesses provided via mobile apps to consumer devices, and business outputs. The business outputs may receive feedback regarding that business, other businesses, or the like. This data output may occur in real time from the central hub, or may be provided only following data analysis or data manipulation from the hub, or both. This data output may occur via any known data format, and may be relationally provided data, as discussed herein. Responsive to this data, action may be undertaken by the data output point. For example, data may be input back into the system based on the received data, physical action may be taken at a particular location, modification to a feedback request or feedback format request may be undertaken, or the like.

Real time aspects of an embodiment may allow businesses the unique ability to interact with the customer at the point of sale, while knowing something of the customers' feelings at that moment. Accordingly, a business may only give a reward or discount to customers deemed honest and customers who, if suitably incentivized, may become loyal customer. For example, a business may only give a discount to someone that had an “average” experience, and who did not previously enter an “average” experience for this business. Thereby, an embodiment may allow for a “scoring” of customer type. In an embodiment, for example, if a customer's history shows that customer to be a high end frequent diner, a restaurant may respond differently to the real time feedback than it would respond to a lower value customer. This may be calculated using a predetermined matrix—for example, a rules engine resident at the feedback hub may have entered, for a particular business: give 10% discount on first visit with at least average feedback; give next visit coupon on second visit; give %5 discount on third visit with at least average feedback; and do nothing on fourth visit.

As a result, embodiments support customer engagement and thus increased revenue growth, and support motivated employees which may lead to revenue and margin growth. Depending on the performance of computer hardware and networks that are used to implement embodiments, customer-initiated feedback may be received in as little as 30 seconds after a user initiates use of app 11. Embodiments are configured to convert normally unstructured feedback into structured and usable insights. Received feedback may be used by a business to publicly celebrate successes while privately addressing problems.

The disclosure additionally encompasses the subject matter recited in the following numbered clauses:

1. A data processing method comprising: a first computing device determining an identity of an entity; selecting and causing displaying a first-level feedback prompt; receiving first-level feedback data at the first computing device; based at least in part upon the first-level feedback data, selecting and causing displaying one of a plurality of second-level feedback prompt sets; receiving one or more second-level feedback data items at the first computing device; selecting and causing displaying one of a plurality of comment screen prompts including suggested comments based at least in part upon the first-level and second-level feedback prompt sets; receiving a Net Promoter Score® input value; creating and causing communicating to a second computer, a data record that associates identifying data, the identity of the entity, the first-level feedback data, the one or more second-level feedback data items, the comment screen data, and the net promoter input value; wherein the method is performed using one or more processors.

2. The method of clause 1 further comprising causing displaying a taxonomy; receiving category selection input identifying a category in the taxonomy; selecting and causing displaying the first-level feedback prompt based in part upon the category selection input.

3. The method of clause 1 further comprising causing displaying a taxonomy; receiving category selection input identifying a category in the taxonomy; selecting and causing displaying the one of the plurality of second-level feedback prompt sets based in part upon the category selection input.

4. The method of clause 1 further comprising, in response to the first-level feedback data indicating “good service,” causing displaying one or more data input fields that are configured to receive a personal identifier and a comment about a person indicated in the personal identifier.

5. The method of clause 1 further comprising causing displaying a comment data input field and one or more suggested favorite comment responses that are selected based upon historical data relating to the first computing device or a user identifier for a user of the first computing device.

6. The method of clause 1 further comprising dynamically modifying the one of the plurality of second-level feedback prompt sets based at least in part upon computer-implemented analysis of the data record and a plurality of other data records previously received and associated with one or more of: other computing devices and the same entity; the same user and the same entity; the same user and other entities.

7. One or more non-transitory storage media storing instructions which, when executed by one or more computing devices, cause performance of the method recited in any of clauses 1 to 6.

8. A computer system, as shown and described.

9. A data processing method, as shown and described.

10. One or more non-transitory storage media storing instructions which, when executed by one or more computing devices, cause performance of the method as shown and described.

11. A computer system, as shown and described in any one or more of the drawing figures and/or in any one or more of the paragraphs of the disclosure.

12. A data processing method, as shown and described in any one or more of the drawing figures and/or in any one or more of the paragraphs of the disclosure.

13. One or more non-transitory storage media storing instructions which, when executed by one or more computing devices, cause performance of the method as shown and described in any one or more of the drawing figures and/or in any one or more of the paragraphs of the disclosure.

### 3.0 Implementation Example

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

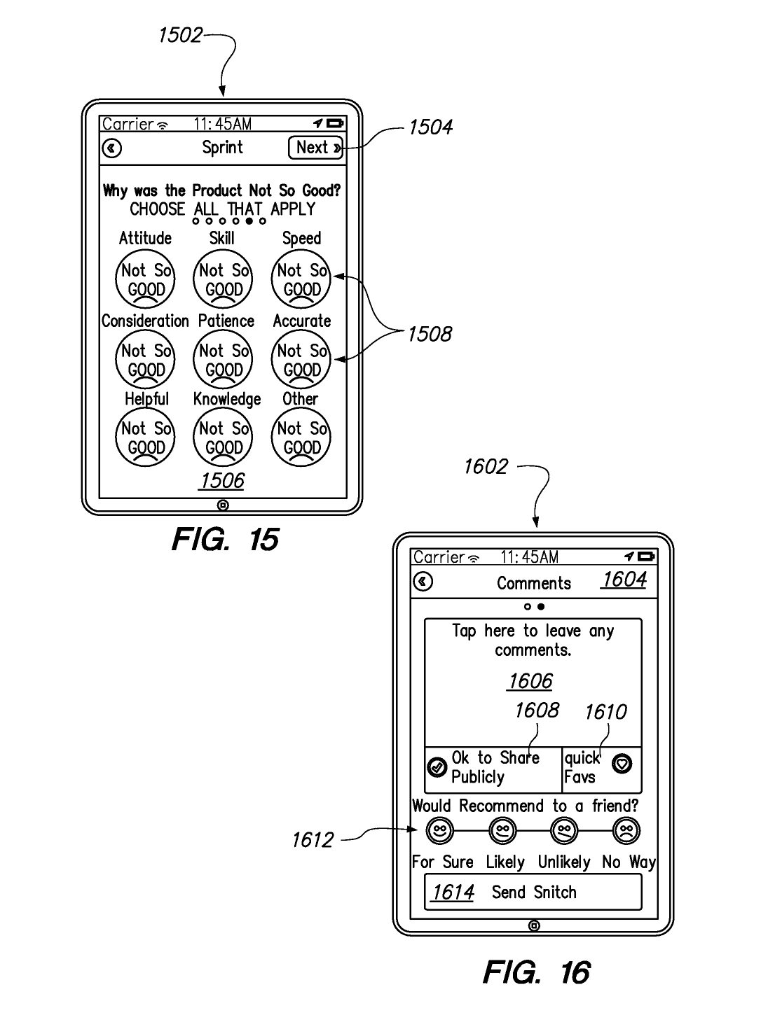

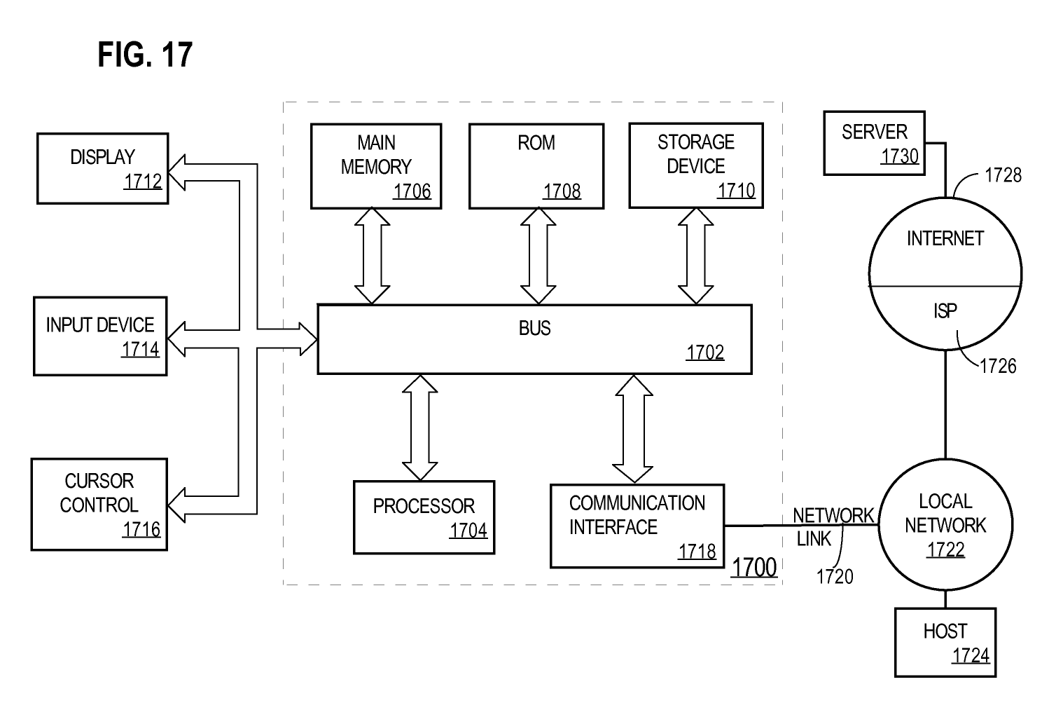

For example, FIG. 17 is a block diagram that illustrates a computer system 1700 upon which an embodiment of the invention may be implemented. Computer system 1700 includes a bus 1702 or other communication mechanism for communicating information, and a hardware processor 1704 coupled with bus 1702 for processing information. Hardware processor 1704 may be, for example, a general purpose microprocessor.

Computer system 1700 also includes a main memory 1706, such as a random access memory (RAM) or other dynamic storage device, coupled to bus 1702 for storing information and instructions to be executed by processor 1704. Main memory 1706 also may be used for storing temporary variables or other intermediate information during execution of instructions to be executed by processor 1704. Such instructions, when stored in non-transitory storage media accessible to processor 1704, render computer system 1700 into a special-purpose machine that is customized to perform the operations specified in the instructions.

Computer system 1700 further includes a read only memory (ROM) 1708 or other static storage device coupled to bus 1702 for storing static information and instructions for processor 1704. A storage device 1710, such as a magnetic disk or optical disk, is provided and coupled to bus 1702 for storing information and instructions.

Computer system 1700 may be coupled via bus 1702 to a display 1712, such as a cathode ray tube (CRT), for displaying information to a computer user. An input device 1714, including alphanumeric and other keys, is coupled to bus 1702 for communicating information and command selections to processor 1704. Another type of user input device is cursor control 1716, such as a mouse, a trackball, or cursor direction keys for communicating direction information and command selections to processor 1704 and for controlling cursor movement on display 1712. This input device typically has two degrees of freedom in two axes, a first axis (e.g., x) and a second axis (e.g., y), that allows the device to specify positions in a plane.

Computer system 1700 may implement the techniques described herein using customized hard-wired logic, one or more ASICs or FPGAs, firmware and/or program logic which in combination with the computer system causes or programs computer system 1700 to be a special-purpose machine. According to one embodiment, the techniques herein are performed by computer system 1700 in response to processor 1704 executing one or more sequences of one or more instructions contained in main memory 1706. Such instructions may be read into main memory 1706 from another storage medium, such as storage device 1710. Execution of the sequences of instructions contained in main memory 1706 causes processor 1704 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 1710. Volatile media includes dynamic memory, such as main memory 1706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1702. Transmission media can also take the form of acoustic or light waves, such as those generated during radio-wave and infra-red data communications.

Various forms of media may be involved in carrying one or more sequences of one or more instructions to processor 1704 for execution. For example, the instructions may initially be carried on a magnetic disk or solid state drive of a remote computer. The remote computer can load the instructions into its dynamic memory and send the instructions over a telephone line using a modem. A modem local to computer system 1700 can receive the data on the telephone line and use an infra-red transmitter to convert the data to an infra-red signal. An infra-red detector can receive the data carried in the infra-red signal and appropriate circuitry can place the data on bus 1702. Bus 1702 carries the data to main memory 1706, from which processor 1704 retrieves and executes the instructions. The instructions received by main memory 1706 may optionally be stored on storage device 1710 either before or after execution by processor 1704.

Computer system 1700 also includes a communication interface 1718 coupled to bus 1702. Communication interface 1718 provides a two-way data communication coupling to a network link 1720 that is connected to a local network 1722. For example, communication interface 1718 may be an integrated services digital network (ISDN) card, cable modem, satellite modem, or a modem to provide a data communication connection to a corresponding type of telephone line. As another example, communication interface 1718 may be a local area network (LAN) card to provide a data communication connection to a compatible LAN. Wireless links may also be implemented. In any such implementation, communication interface 1718 sends and receives electrical, electromagnetic or optical signals that carry digital data streams representing various types of information.

Network link 1720 typically provides data communication through one or more networks to other data devices. For example, network link 1720 may provide a connection through local network 1722 to a host computer 1724 or to data equipment operated by an Internet Service Provider (ISP) 1726. ISP 1726 in turn provides data communication services through the world wide packet data communication network now commonly referred to as the “Internet” 1728. Local network 1722 and Internet 1728 both use electrical, electromagnetic or optical signals that carry digital data streams. The signals through the various networks and the signals on network link 1720 and through communication interface 1718, which carry the digital data to and from computer system 1700, are example forms of transmission media.

Computer system 1700 can send messages and receive data, including program code, through the network(s), network link 1720 and communication interface 1718. In the Internet example, a server 1730 might transmit a requested code for an application program through Internet 1728, ISP 1726, local network 1722 and communication interface 1718.

The received code may be executed by processor 1704 as it is received, and/or stored in storage device 1710, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
at a computing device having one or more hardware processors and having or being operatively coupled to a video display:
displaying, by at least one of the hardware processors, one or more selectable items on the video display in a graphical user interface;
wherein each of the one or more selectable items corresponds to a business to provide feedback on;
obtaining, by at least one of the hardware processors, first user input selecting a selectable item, of the one or more selectable items, corresponding to a particular business to provide feedback on;
after obtaining the first user input, displaying, by at least one of the hardware processors, a first-level feedback prompt on the video display in a graphical user interface, the first-level feedback prompt for providing feedback on the particular business;
wherein the first-level feedback prompt comprises a plurality of binary selectable feedback choices, each of the plurality of binary selectable feedback choices for providing feedback on a corresponding aspect of the particular business, each of the plurality of binary selectable feedback choices consisting of two individual selectable feedback choices for providing particular feedback on the aspect of the particular business corresponding to the binary selectable feedback choice;
obtaining, by at least one of the hardware processors, second user input selecting one or both individual selectable feedback choices of one or more of the plurality of binary selectable feedback choices;
wherein one or more individual selectable feedback choices of the plurality of binary selectable feedback choices are not selected by user input;
selecting, by at least one of the hardware processors, one or more second-level feedback prompts based on the one or more individual selectable feedback choices selected by the second user input including, for each individual selectable feedback choice selected by the second input, (a) selecting, by at least one of the hardware processors, a second-level feedback prompt, of the one or more second-level feedback prompts, for providing further particular feedback on the particular business related to the individual selectable feedback choice selected by the second user input, and (b) displaying, by at least one of the hardware processors, the second-level feedback prompt on the video display in a graphical user interface, the second-level feedback prompt comprising a plurality of additional individual selectable feedback choices for providing the further particular feedback on the particular business related to the individual selectable feedback choice selected by the second user input;
obtaining, by at least one of the hardware processors, third user input selecting one or more additional individual selectable feedback choices of the one or more second-level feedback prompts;
wherein one or more additional individual selectable feedback choices of the one or more second-level feedback prompts is not selected by user input;
sending, by at least one of the hardware processors, to a server via a data network, structured feedback data reflecting at least the one or more individual selectable feedback choices selected by the second user input and the one or more additional individual selectable feedback choices selected by the third user input;
wherein the method is performed by the computing device.

2. The method of claim 1, wherein the second user input selects both individual selectable feedback choices of at least one of the plurality of binary selectable feedback choices.

3. The method of claim 1, wherein at least one of the plurality of binary selectable feedback choices is for providing feedback on a product aspect of the particular business.

4. The method of claim 1, wherein at least one of the plurality of binary selectable feedback choices is for providing feedback on a service aspect of the particular business.

5. The method of claim 1, further comprising sending, by at least one of the hardware processors, to a server via a data network, structured feedback data reflecting at least the one or more individual selectable feedback choices not selected by user input and the one or more additional individual selectable feedback choices not selected by user input.

6. The method of claim 1, wherein:
the computing device is a mobile computing device;
a touch sensitive surface overlays the video display, the touch sensitive surface configured to detect tactile contact with the touch sensitive surface;
wherein the first user input, the second user input, and the third user input is provided by tactile contact with the touch sensitive surface.

7. A computing device having or being operatively coupled to a video display and comprising at least one hardware processor configured to perform the method of claim 1.

8. A computing device having or being operatively coupled to a video display and comprising at least one hardware processor configured to perform the method of claim 2.

9. A computing device having or being operatively coupled to a video display and comprising at least one hardware processor configured to perform the method of claim 3.

10. A computing device having or being operatively coupled to a video display and comprising at least one hardware processor configured to perform the method of claim 4.

11. A computing device having or being operatively coupled to a video display and comprising at least one hardware processor configured to perform the method of claim 5.

12. A mobile computing device having a video display, wherein a touch sensitive surface overlays the video display, the touch sensitive surface configured to detect tactile contact with the touch sensitive surface, the mobile computing device comprising at least one hardware processor configured to perform the method claim 1.
